(19) United States
(12) Patent Application Publication
(10) Pub. No.: US 2017/0015279 A1
(43) Pub. Date: Jan. 19, 2017

(54) WINDSHIELD WIPER BLADE WITH ADJUSTABLE LENGTH

(71) Applicant: Illinois Tool Works Inc., Glenview, IL (US)

(72) Inventors: Martin William Rosas, Cypress, TX (US); Travis Shane Hill, Katy, TX (US); Kenneth Henry Teal, Jersey Village, TX (US)

(73) Assignee: Illinois Tool Works Inc., Glenview, IL (US)

(21) Appl. No.: 15/211,611

(22) Filed: Jul. 15, 2016

Related U.S. Application Data
(60) Provisional application No. 62/192,802, filed on Jul. 15, 2015.

(51) Int. Cl. B60S 1/38

(52) U.S. Cl. CPC B60S 1/3801; B60S 1/381; B60S 2001/3815

(57) ABSTRACT

The present invention relates to a device including a wiper blade having a length measured from a first end of the wiper blade to a second end of the wiper blade that is adjustable without removal of material of the wiper blade and a housing removably connected to the wiper blade. The present invention also relates to a method of adjusting a length of a wiper blade including providing a wiper blade having a first length and adjusting said wiper blade to have a second length different than the first length without removal of material of the wiper blade.

### RELATED APPLICATIONS

The present patent document claims the benefit of the filing date under 35 U.S.C. §119(e) of Provisional U.S. Patent Application Ser. No. 62/192,802, filed Jul. 15, 2015, the entire contents of which are hereby incorporated by reference.

### BACKGROUND

1. Technical Field

The present invention relates to a windshield wiper blade with adjustable length.

2. Background Information

Windshields of automobiles vary in size and require wiper blades of a specific length to appropriately fit each type of windshield. In the past, wiper blades have been manufactured and sold in varying lengths that are fixed. A known wiper blade system for an automobile includes two windshield wiper blades that are each of a fixed length and are aligned with one another. The fixed length of known windshield wiper blades is determined by the automobile manufacturer and its suppliers for each specific automobile and must be sufficient to cover as much surface area of the automobile's windshield as possible when in use. The lack of adjustable length windshield wiper blades implicates several issues for suppliers, retailers and consumers of windshield wiper blades.

With only fixed length windshield wiper blades available, wiper blade suppliers must maintain a supply of inventory for wiper blades of different fixed lengths that appropriately fit each type of automobile. In turn, in order to meet consumer demand, wiper blade retailers must store wiper blades of different fixed lengths and purchase the same from wiper blade suppliers. This practice can be costly for retailers as it requires a retailer to have storage capabilities to store wiper blades of different fixed lengths and to maintain wiper blades of different fixed lengths in stock to service consumers that have automobiles with different windshield sizes. Retailers also have limited shelf, display and floor space to accommodate each supplier's wiper blades. A supplier is therefore constrained by the amount of allocated space that the retailer provides for displaying the supplier's products to consumers. Depending on the amount of allocated shelf and display space, a supplier may not be able to display certain fixed length wiper blades to potential consumers at various retailers. To satisfy consumer demand, suppliers must also incur the cost of purchasing the necessary materials, equipment and supplies to manufacture wiper blades of varying fixed lengths. The lack of adjustable length wiper blades is also burdensome for consumers as wiper blades need to be replaced periodically. Consumers often have difficulty identifying a wiper blade of the appropriate length at a retailer that will appropriately fit the windshield of his or her automobile.

### BRIEF SUMMARY OF THE INVENTION

One aspect of the present invention regards a device that includes a wiper blade including a length that is adjustable without removal of material of the wiper blade and a housing that is removably connected to the wiper blade.

A second aspect of the present invention regards a device that includes a wiper blade including a length that is adjustable via relative movement of two parallel blades and a housing connected to the two parallel blades. The housing includes a plurality of predetermined locations for connection between the housing and the two parallel blades.

A third aspect of the present invention regards a method of adjusting a length of a wiper blade. The method includes providing a wiper blade having a first length and adjusting the wiper blade to have a second length different in magnitude than the first length without removal of material of the wiper blade.

One or more aspects of the present invention provide the advantage of providing a wiper blade that can be adjusted to appropriately fit a windshield of many types of automobiles.

One or more aspects of the present invention provide the advantage of providing a wiper blade for many types of automobiles that can be displayed in a confined space of a retail store.

The accompanying drawings, which are incorporated herein and constitute part of this specification, and, together with the general description given above and the detailed description given below, serve to explain features of the present invention.

### BRIEF DESCRIPTION OF THE DRAWINGS

In the drawings:

FIG. 1 shows a perspective view of a first embodiment of a wiper blade that includes an adjustable length in accordance with the present invention;

FIG. 2 shows a partially exploded perspective view of the wiper blade of FIG. 1;

FIG. 3 shows a side view of the wiper blade of FIG. 1 with a first length;

FIG. 4 shows a side view of the wiper blade of FIG. 1 with a second length different than the first length of FIG. 3;

FIG. 5 shows a top view of the wiper blade of FIG. 1;

FIG. 6 shows a bottom view of the wiper blade of FIG. 1;

FIG. 7 shows an end view of the wiper blade of FIG. 1;

FIG. 8 shows a cross-sectional view taken along lines 8-8 of FIG. 1;

FIG. 9 shows a perspective view of a second embodiment of a wiper blade that includes an adjustable length in accordance with the present invention;

FIG. 10 shows a partially exploded side view of the wiper blade of FIG. 9 with an original length;

FIG. 11 shows another side view of the wiper blade of FIG. 9 with the original length;

FIG. 12 shows another side view of the wiper blade of FIG. 9 with the original length;

FIG. 13 shows a side view of the original length of the wiper blade of FIG. 9 being adjusted to a second length different than the original length;

FIG. 14 shows a side view of the wiper blade of FIG. 9 with the original length;

FIG. 15 shows a side view of the wiper blade of FIG. 9 with a second length;

FIG. 16 shows a cross-sectional view taken along line 16-16 of FIG. 15;

FIG. 17 shows a perspective view of an embodiment of a squeegee to be used with the wiper blade of FIG. 9;

FIG. 18 shows a perspective view of a second embodiment of spoilers that can be used with the wiper blade of FIG. 9;

FIG. 19 shows another perspective view of the second embodiment of the spoilers used with the wiper blade of FIG. 9;

FIGS. 20 and 21 show side views of extending the spoilers in the telescoping formation of the second embodiment of the spoilers used with the wiper blade of FIG. 9;

FIG. 22 shows a cross-sectional view taken along lines 22-22 of FIG. 20;

FIG. 23 shows a perspective view of a third embodiment of a wiper blade that includes an adjustable length in accordance with the present invention;

FIG. 24 shows a cross-sectional view taken along lines 24-24 of FIG. 23;

FIG. 25 shows a cross-sectional view taken along lines 25-25 of FIG. 23;

FIG. 26 shows a perspective view of the wiper blade of FIG. 23 with a second length;

FIG. 27 shows an enlarged view identified as FIG. 27 in FIG. 26;

FIG. 28 shows a cross-sectional view taken along lines 28-28 of FIG. 26;

FIG. 29 shows an exploded cross-sectional view of moving the wiper blade of FIG. 23 from a first position to a second position;

FIG. 30 shows an exploded cross-sectional view of the wiper blade of FIG. 23 in the second position;

FIG. 31 shows a perspective view of a fourth embodiment of a wiper blade that includes an adjustable length in accordance with the present invention in an unlocked position with a first length;

FIG. 32 shows a cross-sectional view taken along lines 32-32 of FIG. 31;

FIG. 33 shows a cross-sectional view taken along lines 33-33 of FIG. 31;

FIG. 34 shows a perspective view of the wiper blade of FIG. 31 with a second length in a locked position;

FIG. 35 shows a cross-sectional view taken along lines 35-35 of FIG. 34;

FIG. 36 shows a bottom view of the third embodiment of the wiper blade of FIG. 23 or the fourth embodiment of the wiper blade of FIG. 31;

FIG. 37A shows a perspective view of an embodiment of end caps for the third or fourth embodiments of the wiper blade of FIGS. 23 and 31;

FIG. 37B shows a side view of the end cap of FIG. 37A;

FIG. 37C shows a bottom view of the end cap of FIG. 37A;

FIG. 38 shows a perspective view of a fifth embodiment of a wiper blade that includes an adjustable length in accordance with the present invention;

FIG. 39 shows a perspective view of the wiper blade of FIG. 38;

FIG. 40 shows a top view of the wiper blade of FIG. 38;

FIG. 41 shows a bottom view of the wiper blade of FIG. 38;

FIG. 42 shows an alternate embodiment for the housing of the wiper blade of FIG. 38;

FIG. 43 shows a perspective view of a sixth embodiment of a wiper blade that includes an adjustable length in accordance with the present invention;

FIG. 44 shows a top view of the wiper blade of FIG. 43;

FIG. 45 shows a side view of the wiper blade of FIG. 43;

FIG. 46 shows a partial perspective view of a cover over a housing of the wiper blade of FIG. 43;

FIG. 47 shows a partial perspective view of the cover partially removed from the housing of the wiper blade of FIG. 43;

FIG. 48 shows a partial side view of the wiper blade of FIG. 43 with the cover removed from the housing;

FIG. 49A shows a perspective view of the cover of the wiper blade of FIG. 43; and

FIG. 49B shows a perspective view of a cover latch of the cover of the wiper blade of FIG. 43.

### DETAILED DESCRIPTION OF THE PREFERRED EMBODIMENTS

In the following detailed description of the various wiper blade embodiments, like elements and structures are numbered or labeled alike.

### First Embodiment

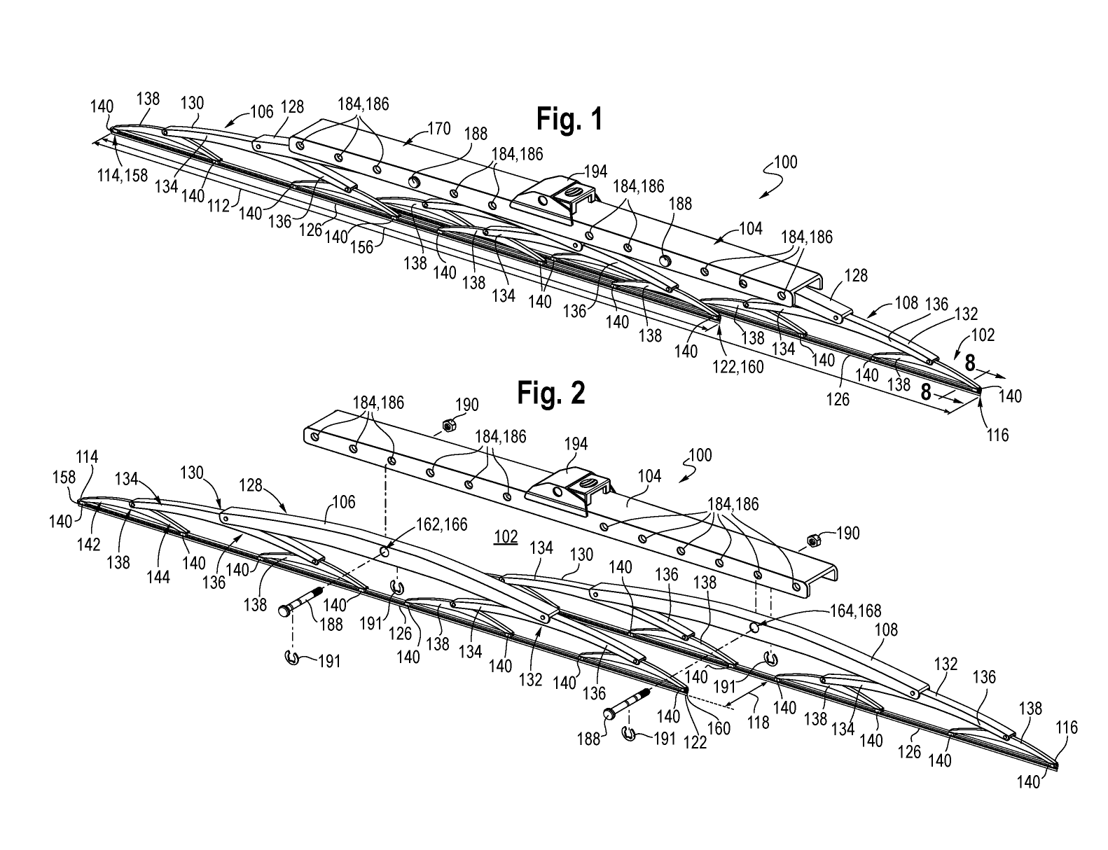

FIGS. 1-8 show a device 100 including a wiper blade 102 that has an adjustable length and a housing 104 that is removably connected to the wiper blade 102. The wiper blade 102 includes a first blade 106 and a second blade 108 that are parallel to one another along a longitudinal direction of the device 100 and offset in a second direction perpendicular to the longitudinal direction to permit the first blade 106 and the second blade 108 to move relative to one another when adjusting the length of the wiper blade 102. The length 112 of the wiper blade 102 is defined from a free end 114 of the first blade 106 to a free end 116 of the second blade 108. Preferably, the length 112 of the wiper blade 102 may range from 12 to 28 inches; however, the length 112 may be less than 12 inches or more than 28 inches to appropriately fit the windshield of an automobile. As shown in FIG. 2, the offset distance 118 between the first blade 106 and the second blade 108 is the distance along the previously mentioned second direction as measured from the first blade 106 to the second blade 108. The offset distance 118 is sufficient to avoid contact between the first blade 106 and the second blade 108. The offset distance 118 is also minimized to allow efficient distribution of the pressure forces along the length 112 of the wiper blade 102. The offset distance 118 may range from 0.5 to 1.0 inches; however, the offset distance may be smaller or larger so long as there is a sufficient distance to avoid contact between the first and second blades 106, 108.

The first blade 106 and the second blade 108 each include a conventional blade, such as a so-called bridge blade or a beam blade, and are both of a fixed length. The fixed length of the first blade 106 and the fixed length of the second blade 108 may be the same or different. Preferably, the fixed lengths of the first blade 106 and the second blade 108 may range from 6 to 14 inches; however, the fixed lengths may be less than 6 inches or more than 14 inches to appropriately fit the windshield of an automobile. The fixed lengths of the first blade 106 and the second blade 108 are of a sufficient length such that when the wiper blade 102 is at its maximum length, a portion of the first blade 106 and a portion of the second blade 108 cover the same area of a windshield to prevent an area of non-coverage during use. In other words, as shown in FIG. 6, the first blade 106 and the second blade 108 include an overlap length 120 defined from a second free end 122 of the first blade 106 to a second free end 124 of the second blade 108. The overlap length 120 may range from 1.25 inches to 15.75 inches; however, the overlap length 120 may be smaller or larger so long as the overlap length 120 is sufficient to prevent an area of non-coverage during use. The first blade 106 and the second blade 108 each include a squeegee 126 that contacts a windshield of an automobile to wipe the windshield. The squeegee 126 may be made of an elastomeric material such as rubber, silicone or other elastomeric material.

As mentioned previously, the first blade 106 and the second blade 108 may be variations of known wiper blades, such as wiper blades currently made and/or sold by ITW Global Brands, ADM21 Co., LTD., Anco, Bosch, Corea Autoparts Producing Corp., KCW Corporation, Proline, Trico and Valeo, and may be used in connection with the housing 104. However, such known wiper blades may be bulky. Preferably, the first blade 106 and the second blade 108 are designed for the device 100 and include a combined maximum width that would be less than the combined maximum width of two known wiper blades positioned side by side including the offset distance 118 between the first blade 106 and the second blade 108.

As shown in FIGS. 1-8, in one embodiment, the first blade 106 or the second blade 108 or both may be a so-called bridge blade. In this case, the first blade 106 includes a frame 128. The material of the frame 128 may include steel, plastic, metal or an elastomer. The material of the frame 128 may be the same material as the material of the housing 104. The frame 128 includes two sub-frames 130, 132. Each sub-frame 130, 132 includes a first arm 134 and a second arm 136. The first and second arms 134, 136 of each sub-frame 130, 132 may include a sub-sub-frame 138 or a clamp-shaped end 140 connected to the squeegee 126. For example, in one embodiment, ends of the first arm 134 and the second arm 136 each include a clamp-shaped end that is connected to the squeegee 126. In an alternative embodiment, the first arm 134 may include a clamp-shaped end and the second arm 136 may include the sub-sub-frame 138. The sub-sub-frame 138 includes a first arm 142 and a second arm 144. The first and second arms 142, 144 of the sub-sub-frame 138 each include a clamp-shaped end 140 that is connected to the squeegee 126. In another embodiment, as shown in FIG. 2, the first and second arms 134, 136 of the sub-frame 130, 132 may each include the sub-sub-frame 138 with clamp-shaped ends 140.

In an alternative embodiment, the first blade 106 or the second blade 108 or both of the embodiments of FIGS. 1-8 may be replaced by a so-called beam blade (not shown). In this case, a beam blade replacing the first blade 106 includes a frame, and an adaptor for connecting the beam blade to the housing 104. The beam blade replacing the second blade 108 has a structure similar to the beam blade replacing the first blade 106. Thus, the following discussion regarding the beam blade replacing the first blade 106 applies to the beam blade replacing the second blade 108. The material of the frame and the adaptor may include steel, plastic, metal or an elastomer. The frame includes a first end, a second end, and a longitudinal length, which is defined as the length from the first end to the second end of the frame. The adaptor is located in the center of the frame, or in other words, half way along the longitudinal length of the frame. The frame includes a slot for receiving a first spline and a second spline. The first and second splines may slide along the slot of the frame. The adaptor includes a first opening to receive the first spline and a second opening to receive the second spline. The first and second openings of the adaptor are located on opposite sides of the adaptor. The first spline includes a length defined from the first end of the frame to the first opening of the adaptor. The second spline includes a length defined from the second end of the frame to the second opening of the adaptor. Thus, the first and second splines do not overlap or connect with one another. The beam blades replacing the first and second blades 106, 108 also each include a first spoiler, a second spoiler, a first cap, a second cap, and the squeegee 126. The frame further includes an opening for receiving the squeegee 126. The squeegee 126 can slide along the opening. The first and second caps are positioned at the first and second ends, respectively, of the frame. The first and second caps each include a stop that prevents the squeegee 126 from sliding beyond the first and second ends of the frame. The first spoiler covers the first spline and is connected to the first cap and the adaptor. The second spoiler covers the second spline and is connected to the second cap and the adaptor.

As shown in FIGS. 7-8, in one embodiment, the squeegee 126 includes a tip 146 and a top portion 148. The top portion 148 includes indentations 150 on a first side 152 and a second side 154 of the squeegee 126. The indentations 150 are located along a horizontal length 156 of the squeegee 126. As shown in FIG. 1, the horizontal length 156 of the squeegee 126 is defined from a first free end 158 of the squeegee 126 to a second free end 160 of the squeegee 126. The clamp-shaped ends 140 are connected to the squeegee 126 by being inserted into the indentations 150 and engaging the squeegee 126. The squeegee 126 may also include a support element (not shown) that is embedded in the squeegee 126 to provide support along the horizontal length 156 of the squeegee 126. The support element may include a steel, plastic, metal or an elastomer material.

In FIG. 2, the first blade 106 and the second blade 108 also each include an adaptor 162, 164 for connecting the first blade 106 and the second blade 108 to the housing 104. The adaptors 162, 164 are positioned in a center portion of the first blade 106 and the second blade 108, respectively. The single adaptor 162, 164 for each blade 106, 108 also permits the first blade 106 and the second blade 108 to pivot about the center of the first blade 106 and the second blade 108, which enables the first blade 106 and the second blade 108 to move across a longitudinal axis and a lateral axis of a windshield of an automobile. While more than one adaptor 162, 164 on each of the first blade 106 and the second blade 108 could be used, it may cause the first blade 106 and the second blade 108 to be fixed and not permitted to pivot. The material of the adaptors 162, 164 may be the same material as the material of the housing 104. Some materials contemplated for the adaptors 162, 164 include plastic, metal or an elastomer. The adaptors 162, 164 may be integral with the first and second blades 106, 108 as shown in FIG. 2 or removably connected therefrom.

The adaptor 162 of the first blade 106 may include an opening 166 and the adaptor 164 of the second blade 108 may include an opening 168 to attach the first blade 106 and the second blade 108 to the housing 104 through a pin and lock assembly. Other types of adaptors 162, 164 may be used that permit removable attachment of the first blade 106 and the second blade 108 with the housing 104 including a snap and lock assembly or a snap and fit assembly, a nut and bolt assembly and other fasteners, a hook and loop assembly, clamps, and spring clips.

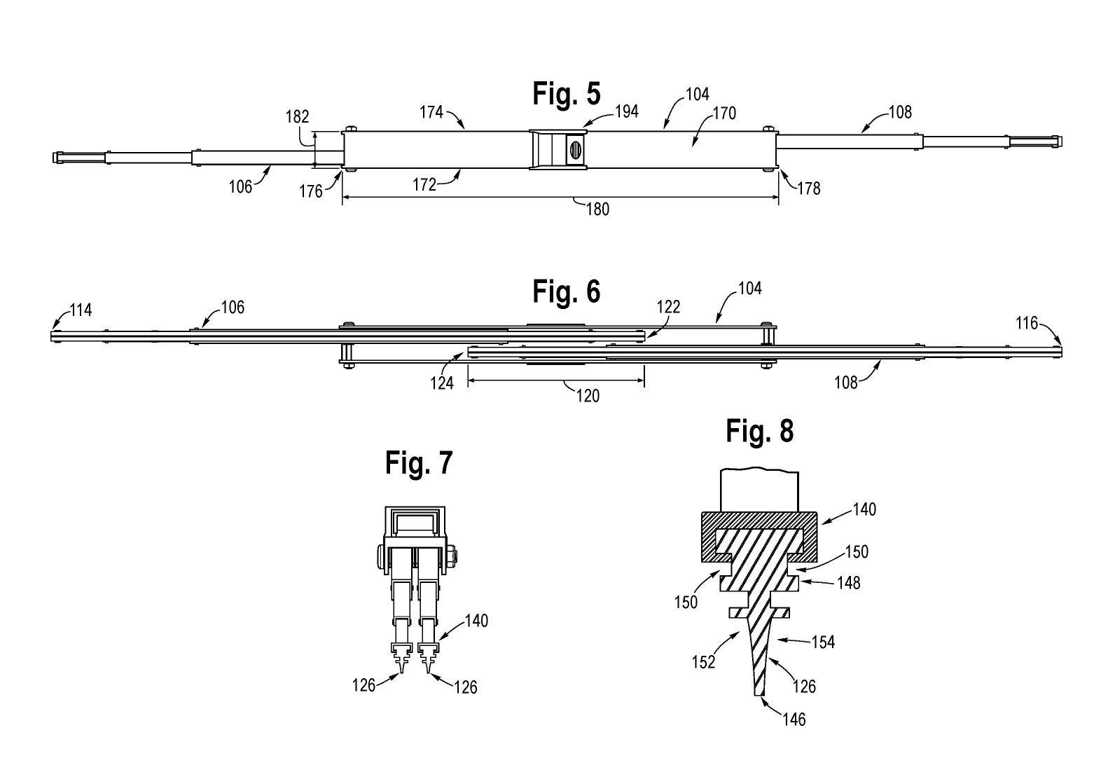

As shown in FIG. 5, the housing 104 of the device 100 includes a top wall 170, a first wall 172 integral with the top wall 170, and a second wall 174 integral with the top wall 170 and parallel to the first wall 172. The housing 104 includes a first end 176, a second end 178, a length 180 defined from the first end 176 to the second end 178, and a width 182 defined from the perpendicular distance between the first wall 172 and the second wall 174. The material of the housing 104 may be the same material as the material of the adaptor 162 of the first blade 106 and of the adaptor 168 of the second blade 108. As described in more detail below, FIG. 2 shows the first blade 106 and the second blade 108 connected to the housing 104 through a pin and lock assembly. As discussed previously, other types of adaptors 162,164 may be used that permit removable attachment of the first blade 106 and the second blade 108 with the housing 104.

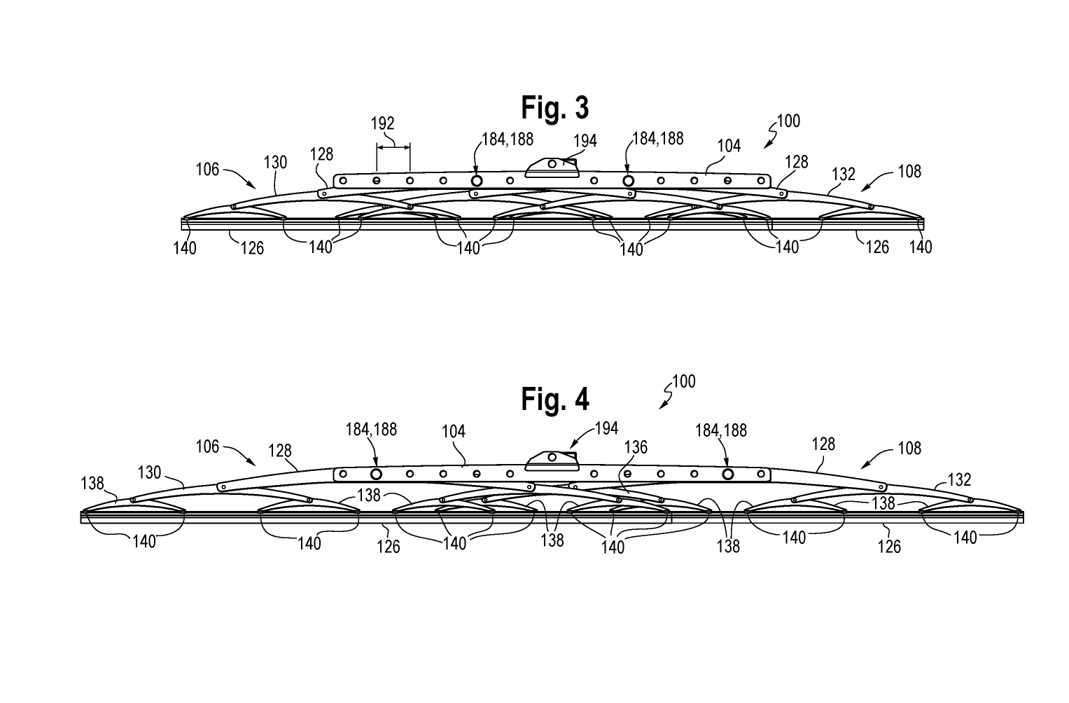

As shown in FIGS. 3 and 4, at least two predetermined locations 184 are provided along each of the first and second walls 172, 174 of the housing 104 for connecting the first blade 106 and the second blade 108 with the housing 104. When a pin and lock assembly is used, as shown in FIG. 2, the first and second walls 172, 174 each include at least two openings 186 at each of the at least two predetermined locations 184 that align with the opening 166 of the adaptor 162 of the first blade 106 and the opening 168 of the adaptor 164 of the second blade 108 for connecting the first blade 106 and the second blade 108 with the housing 104. For example, a pin 188 can be inserted through the opening 186 on the first wall 172 of the housing at one of the predetermined locations 184, through the opening 166 of the adaptor 162 of the first blade 106, and then through the opening 186 on the second wall 174 of the housing 104 for attaching the first blade 106 with the housing 104. A lock 190 is attached to the pin 188 on the outside of the second wall 174 of the housing 104 to attach the first blade 106 with the housing 104. To maintain the offset distance 118 between the first blade 106 and the second blade 108, washers, nuts or other locking devices 191 may be included and positioned on the pin 188 (or any other type of adaptor 162, 164 described previously) to prevent the first blade 106 and the second blade 108 from moving along the pin 188 during use and to prevent the first and second blades 106, 108 from interacting with one another during use.

The first and second walls 172, 174 of the housing 104 may each include two to thirty openings 186; however, the number of openings 186 will vary depending on the length 180 of the housing 104 and the desired length 112 of the wiper blade 102. The distance 192 between the openings 186, which is the horizontal distance between the center of one opening 186 to the center of an adjacent opening 186 as shown in FIG. 3, is approximately 0.5 inches. The distance 192 between adjacent openings 186 may be constant or vary to achieve specific lengths 112 of the wiper blade 102. The at least two predetermined locations 184 of the openings 186 of the housing 104 permit multiple attachment locations for the first blade 106 and the second blade 108 with the housing 104. The multiple attachment locations allow the length 112 of the wiper blade 102 to be adjusted by moving the first blade 106 or the second blade 108 or both to a new attachment location. For example, as shown in FIG. 3, when the first blade 106 is attached to the housing 104 at a first predetermined location 184 and the second blade 108 is attached to the housing 104 at a first predetermined location 184, the wiper blade 102 has a first length. As shown in FIG. 4, to lengthen or shorten the length 112 of the wiper blade 102 to a second length different than the first length, the first blade 106 is removed from the first predetermined location 184 and attached to the housing 104 at a second predetermined location 184 different than the first predetermined location 184 that results in the desired length being achieved. The second blade 108 may also be moved to adjust the length 112 of the wiper blade 102.

The housing 104 of the device 100 also includes a bracket 194 positioned on the top wall 170 and in the center portion of the housing 104. The bracket 194 is secured to the housing 104 by nuts and bolts, welding or other secure attachment devices. The bracket 194 is configured to engage a universal connector (not shown) for connecting the housing 104 to multiple types of wiper arms used for different types of automobiles. Examples of such universal connectors are described in U.S. patent application Ser. No. 14/643,255, filed on Mar. 10, 2015, U.S. patent application Ser. No. 13/836,333, filed on Mar. 15, 2013, and U.S. patent application Ser. No. 13/836,529, filed on Mar. 15, 2013, the entire contents of each of which are incorporated herein by reference.

### Second Embodiment

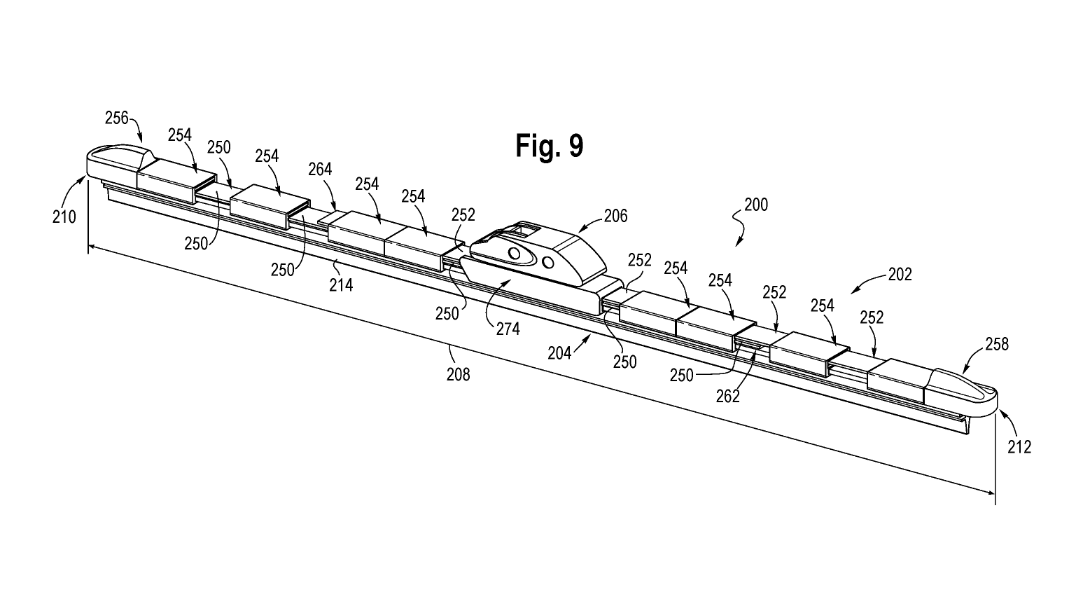

FIGS. 9-22 show a second embodiment of an adjustable wiper blade. In particular, a device 200 includes a wiper blade 202 having a single blade 204 and a connector 206 that is removably connected to the wiper blade 202. The wiper blade 202 includes a length 208, which is defined from a first free end 210 of the single blade 204 to a second free end 212 of the single blade 204. Preferably, the length 208 of the wiper blade 202 may range from 12 to 28 inches; however, the length 208 may be less than 12 inches or more than 28 inches to appropriately fit the windshield of an automobile.

The single blade 204 includes a conventional blade, such as a bridge blade or a beam blade similar to the bridge blade and beam blade described previously with respect to the embodiment of FIGS. 1-8. As shown in FIGS. 9-22, the single blade 204 is a beam blade. The single blade 204 includes a squeegee 214 that contacts a windshield of an automobile to wipe the windshield. The squeegee 214 may include rubber, silicone or other elastomeric material. As shown in FIG. 17, the squeegee 214 also includes a tip 216 and a top portion 218 that includes a first side 220 and a second side 222.

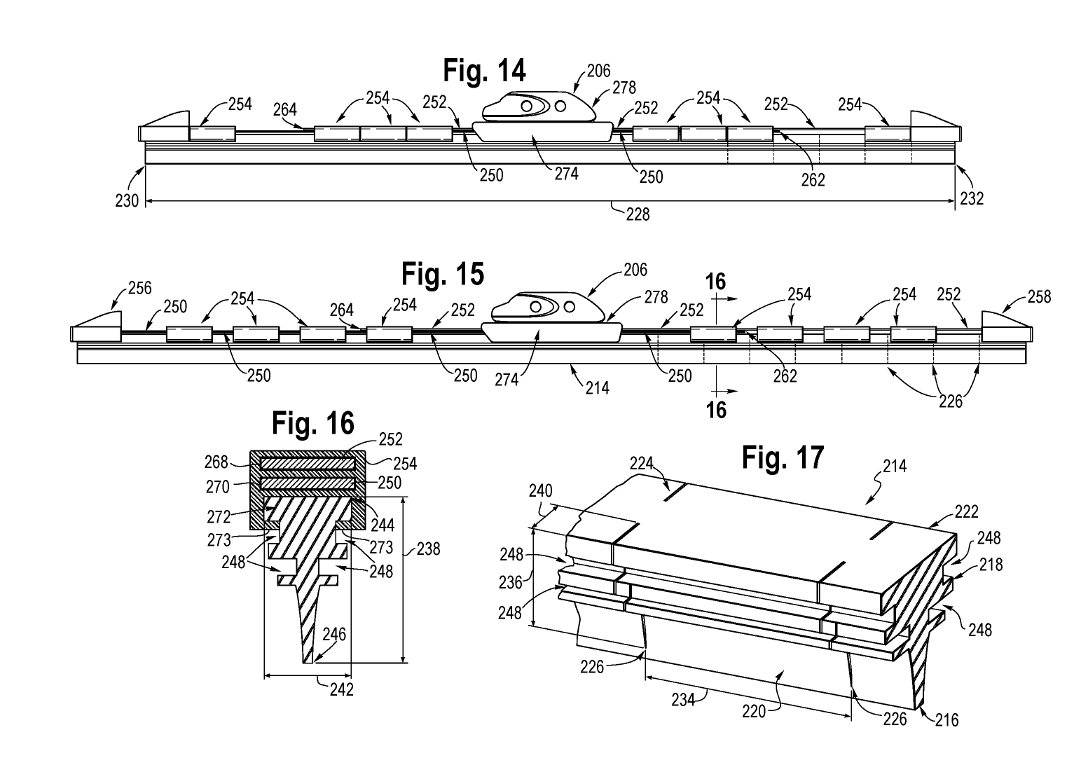

As shown in FIG. 17, the squeegee 214 includes markings 224 at predetermined locations 226 along a horizontal length 228 of the squeegee 214. The horizontal length 228 of the squeegee 214 is defined from a first free end 230 of the squeegee 214 to a second free end 232 of the squeegee 214 as shown in FIG. 14. The markings 224 at the predetermined locations 226 allow the horizontal length 228 of the squeegee 214 to be adjusted to a length for a specific type of automobile. The markings 224 identify locations where a consumer cuts, rips or otherwise shortens the horizontal length 228 of the squeegee 214. The horizontal distance 234 between consecutive markings 224 may vary from 1.0 to 1.25 inches, and may increase or decrease to achieve the desired horizontal length 228 of the squeegee 214. In one embodiment, as shown in FIG. 17, the markings 224 include a height 236 along a vertical height 238 of the squeegee 214 and a width 240 along a width 242 of the squeegee 214. The vertical height 238 of the squeegee 214 is defined from a top end 244 of the squeegee 214 to a bottom end 246 of the squeegee 214. The width 242 of the squeegee 214 is defined from the first side 220 of the top portion 218 to the second side 222 of the top portion 218. The height 236 of the markings 224 is smaller than the vertical height 238 of the squeegee 214, and the width 240 of the markings 224 is smaller than the width 242 of the squeegee 214. The top portion 218 of the squeegee 214 also includes indentations 248 on the first side 220 and the second side 222 of the squeegee 214 that are positioned along the horizontal length 228 of the squeegee 214.

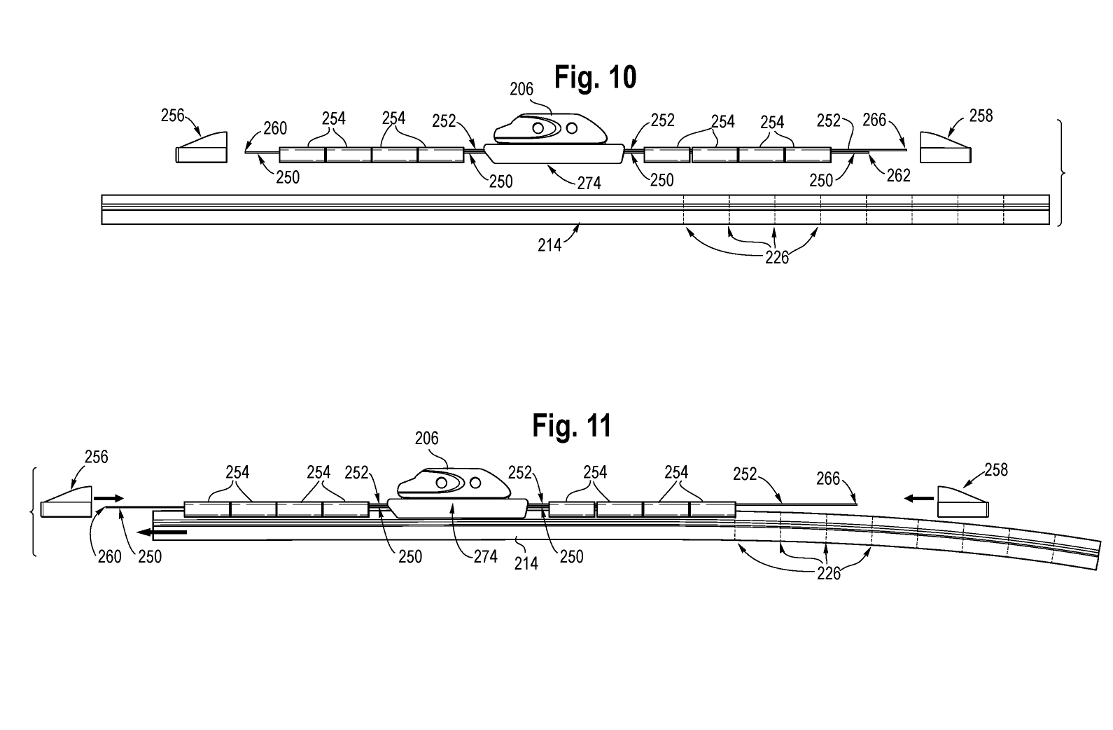

As shown in FIGS. 9-16 and 22, the wiper blade 202 also includes a first spline 250, a second spline 252, and spoilers 254 that interact with the first spline 250 and the second spline 252. The wiper blade 202 also includes a first cap 256 located at the first free end 210 of the single blade 204 and connected with the first spline 250 and engaged within the indentations 248 of the squeegee 214 and a second cap 258 located at the second free end 212 of the single blade 204 and connected with the second spline 252 and engaged within the indentations 248 of the squeegee 214. The first spline 250 includes a first end 260 and a second end 262. As shown in FIG. 10, the first end 260 of the first spline 250 is attached to the first cap 256, and the second end 262 of the first spline 250 is not attached to the first cap 256 or the second cap 258. The second spline 252 includes a first end 264 and a second end 266. The second end 266 of the second spline 252 is attached to the second cap 258, and the first end 264 of the second spline 252 is not attached to the first cap 256 or the second cap 258. The first cap 256 and the second cap 258 do not interact with one another.

The first spline 250 is rectangular in shape and is curved. The second spline 252 has a shape similar to the first spline 250. As shown in FIGS. 16 and 22, the second spline 252 lies above and is spaced from the first spline 250 so that there is no interaction between the splines 250, 252. The materials of the first and second splines 250, 252, the first and second caps 256, 258, and the spoilers 254 may include steel, plastic, metal or an elastomer. The materials of the first and second splines 250, 252, the first and second caps 256, 258, and the spoilers 254 may be the same.

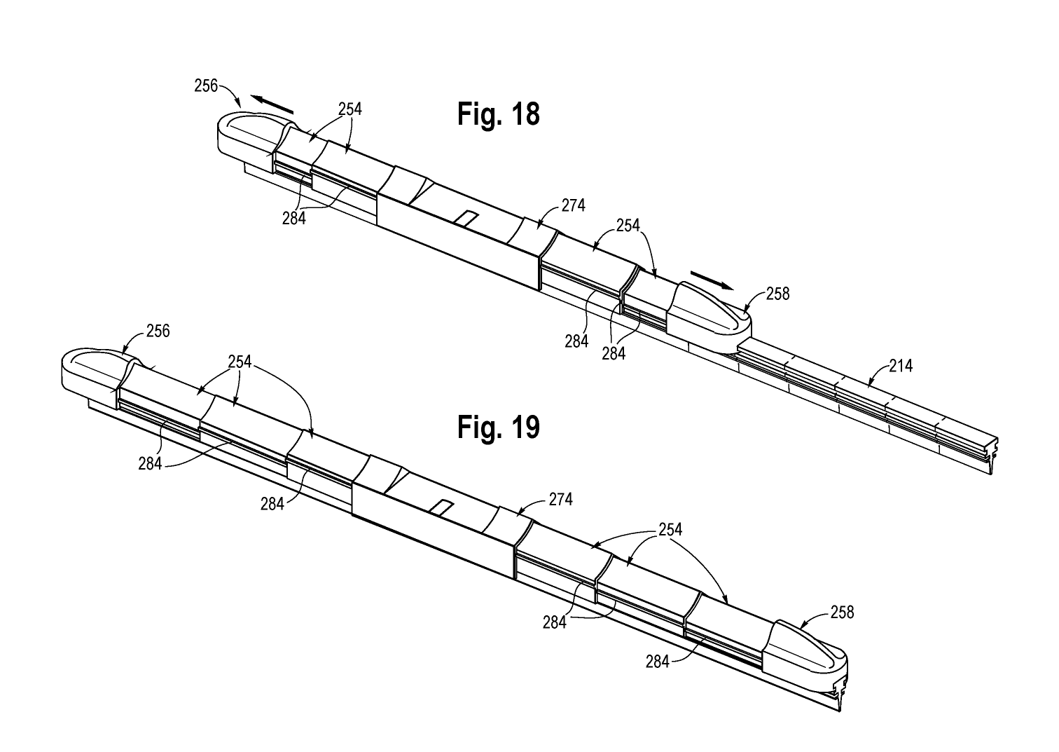

In one embodiment, as shown in FIGS. 9-16, the spoilers 254 include a bridge formation. In an alternative embodiment, as shown in FIGS. 18-22, the spoilers 254 include a telescoping formation. In the bridge formation, the spoilers 254 do not overlap with one another. In the telescoping formation, the spoilers 254 may overlap with one another, such that one spoiler may slide into an adjacent spoiler to decrease the length 208 of the wiper blade 402. In both embodiments, the spoilers 254 may interface with each other or be spaced apart to permit the length 208 of the wiper blade 202 to increase or decrease. The spoilers 254 and the first and second splines 250, 252 provide structural support for the squeegee 214 to maintain a vertical position of the squeegee 214 when in use, allow distribution of the pressure forces on the single blade 204, and provide stability when the wiper blade 202 is in use.

As shown in FIG. 16, each of the spoilers 254 includes a first slot 268, a second slot 270, and a third slot 272. The first spline 250 of the wiper blade 202 is positioned within the second slot 270 of the spoilers 254, and the second spline 252 of the wiper blade 202 is positioned within the first slot 268 of the spoilers 254. The first spline 250 and the second spline 252 are positioned within the second slot 270 and the first slot 268, respectively, of the spoilers 254 such that the first and second splines 250, 252 slide through the second slot 270 and the first slot 268, respectively, of the spoilers 254. In other words, the second slot 270 of the spoilers 254 slidably receives the first spline 250, and the first slot 268 slidably receives the second spline 252. The third slot 272 of the spoilers 254 slidably receives the squeegee 214. The third slot 272 includes flanges 273 to create a T-shape. The squeegee 214 is positioned within the third slot 272 of the spoilers such that the flanges 273 of the third slot 272 are inserted into the indentations 248 of the squeegee 214 so the flanges 273 engage the squeegee 214. The connection between the third slot 272 of the spoilers 254 and the indentations 248 of the squeegee 214 permit the spoilers 254 to slide along the horizontal length 228 of the squeegee 214. One of the spoilers 254 is a main spoiler 274. The main spoiler 274 is located in a center portion of the wiper blade 202 and is fixed.

In one embodiment, the first and second caps 256, 258 each include a first slot, a second slot, and a third slot similar to the first, second and third slots 268, 270, 272 of the spoilers 254. In another embodiment, the first and second caps 256, 258 each include two slots. For example, the first cap 256 includes a first slot to receive the first spline 250 and a second slot to receive the indentations 248 of the squeegee 214, and the second cap 258 includes a first slot to receive the second spline 252 and a second slot to receive the indentations 248 of the squeegee 214. Note that the spoilers 254 and the main spoiler 274 preferably have a profile similar to that of the caps 256, 258 so as to provide an overall aesthetically pleasing look for the wiper blade 202.

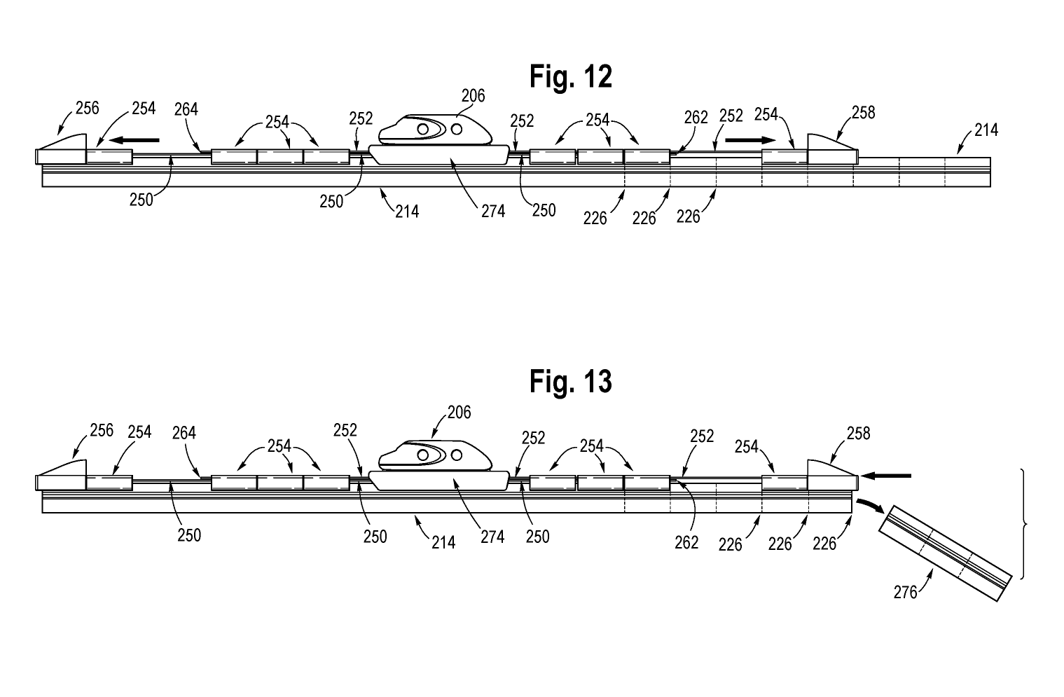

The connection between the first and second caps 256, 258 and the indentations 248 of the squeegee 214 permits one of the first and second caps 256, 258 to slide along the horizontal length 228 of the squeegee 214 to a desired location. For example, one of the first and second caps 256, 258 may be secured to the squeegee 214 and the other of the first and second caps 256, 258 may include an opening to allow the cap to slide along the squeegee 214. As shown in FIG. 12, to adjust the length 208 of the wiper blade 202, one of the first cap 256 or the second cap 258 may be moved along the horizontal length 228 of the squeegee 214. For example, the first cap 256 may be secured to the squeegee 214 such that when the first cap 256 is moved in the direction of the first free end 210 of the single blade 204 to a predetermined location 226 on the horizontal length 228 of the squeegee 214, the first cap 256 pulls the first spline 250 and the spoilers 254 positioned between the main spoiler 274 and the first free end 210 to extend away from the main spoiler 274 and to increase the length 208 of the wiper blade 202. In such an example, during adjustment, the second cap 258 and the spoilers 254 are slid along the indentations 248 of the squeegee 214. As shown in FIG. 13, once the desired predetermined location 226 is reached, the consumer may rip, tear, cut or otherwise remove the excess squeegee 276 at the marking 224 that extends beyond the predetermined location 226.

In one embodiment shown in FIGS. 12 and 13, one of the first and second caps 256, 258 includes a lock or a stop that prevents the squeegee 214 from extending beyond either the first or second cap 256, 258. The other cap 256, 258 has a slot that corresponds to the slot 272 of the spoilers 254 and extends through both ends of the cap 256, 258. The squeegee 214 is permitted to extend beyond the other first or second cap 256, 258 until the consumer rips, tears, cuts, or otherwise removes the excess squeegee 276 at the marking 224 that extends beyond the predetermined location 226. After removal of the excess squeegee 276, the squeegee 214 is then flush with the first or second cap 256, 258 such that it is locked into place and cannot extend beyond either the first or second cap 256, 258.

In another embodiment, the squeegee 214 is permitted to extend beyond both the first and second caps 256, 258 until the consumer rips, tears, cuts or otherwise removes the excess squeegee 276 that extends beyond the first and second caps 256, 258. After removal of the excess squeegee 276, the squeegee 214 is then flush with the first and second caps 256, 258 such that it is locked into place and cannot extend beyond either the first or second cap 256, 258. Preferably, after the excess squeegee 276 is removed, a length of the first spline 250, which is defined from the first end 260 of the first spline 250 to the main spoiler 274, is the same as a length of the second spline 252, which is defined from the second end 266 of the second spline 252 to the main spoiler 274. In other words, the length of the wiper blade 202 is the same on either side of the main spoiler 274. The first and second splines 250, 252 and the spoilers 254 are then locked into position via an adhesive or other mechanical attachment devices. Similarly, when the first cap 256 is moved in the direction of the second free end 212 of the single blade 204, the first cap 256 pushes the first spline 250 and the spoilers 254 positioned between the main spoiler 274 and the first free end 210 toward the main spoiler 274 to decrease the length 208 of the wiper blade 202.

Thus, in order to adjust the length 208 of the wiper blade 202, the first and second caps 256, 258 are pushed toward one another, pulled away from one another, or a combination of pulling and pushing, which also moves the first and second splines 250, 252 and the spoilers 254. Once the desired length 208 of the wiper blade 202 is reached, the consumer rips, tears, cuts, or otherwise removes the excess squeegee 276 at the marking 224 that extends beyond the first cap 256 or the second cap 258. After the excess squeegee 276 is removed, the first and second splines 250, 252 and the spoilers 254 are locked into position.

The main spoiler 274 of the wiper blade 202 also includes a bracket 278 positioned in a center portion of the main spoiler 274. The bracket 278 is secured to the main spoiler 274 by a snap and lock assembly or a snap and fit assembly, a nut and bolt assembly and other fasteners, welding or other secure attachment devices. The bracket 278 is configured to engage the connector 206. The connector 206 includes a universal connector (not shown) for connecting the wiper blade 202 to multiple types of wiper arms used for different types of automobiles. Examples of such universal connectors are described in U.S. patent application Ser. No. 14/643,255, filed on Mar. 10, 2015, U.S. patent application Ser. No. 13/836,333, filed on Mar. 15, 2013, and U.S. patent application Ser. No. 13/836,529, filed on Mar. 15, 2013, the entire contents of which are incorporated herein by reference. Also, other exterior shapes for the connector 206 are possible without departing from the spirit of the present invention. For example, the non-planar shape of the sides of the connector 206 can be replaced by planar sides.

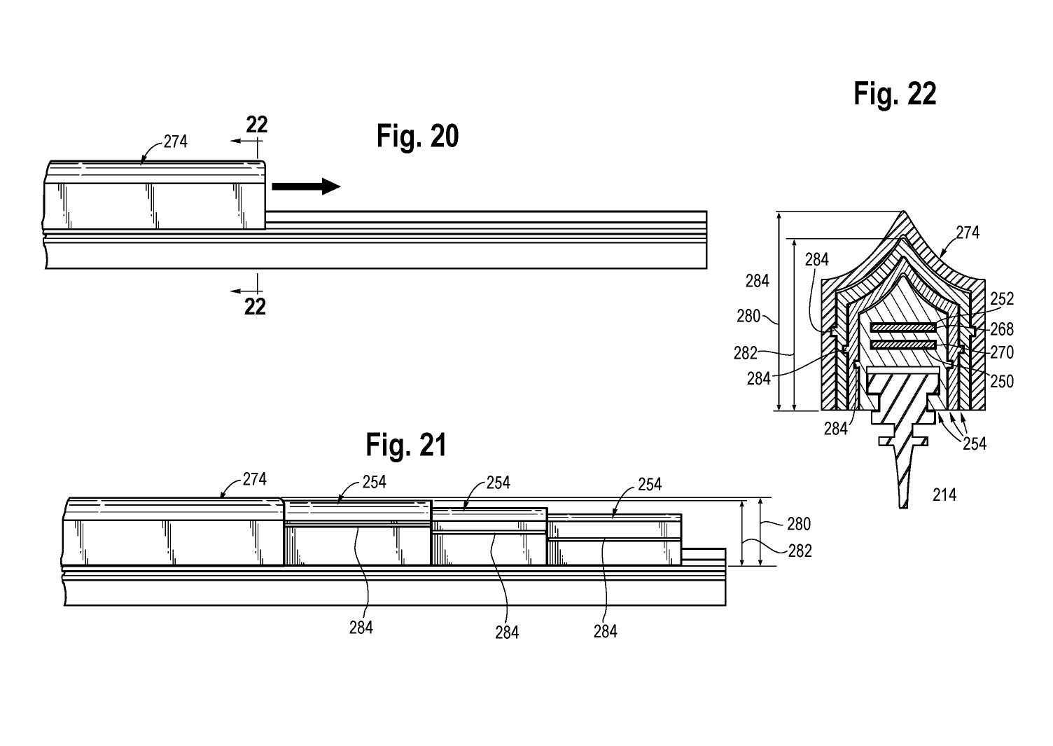

As previously described, FIGS. 18-22 show a second embodiment of the spoilers 254 that include a telescoping formation. In FIG. 20, all of the spoilers 254 are retracted within the cavity of the main spoiler 274. As shown in FIG. 21, when the spoilers 254 are pulled away from the cavity of the main spoiler 274, the spoilers 254 have varying heights to permit the spoilers 254 to telescope within a cavity of an adjacent spoiler 254. For example, the main spoiler 274 includes a height 280. The spoilers 254 adjacent to the main spoiler 274 include a height 282, which is smaller than the height 280 of the main spoiler 274 such that spoilers 254 adjacent to the main spoiler 274 may slide into the cavity of the main spoiler 274. In other words, in the direction of either the first cap 256 or the second cap 258 from the main spoiler 274, the height of the spoilers 254 decrease.

FIG. 22 shows a cross-sectional view of spoilers 254 in the telescoping formation. As shown in FIGS. 18-19, the spoilers 254 adjacent to the first and second caps 256, 258 are attached to the first and second caps 256, 258 such that when the first and second caps 256, 258 are pulled away from the direction of the main spoiler 274, the spoilers 254 telescope outward to increase the length 208 of the wiper blade 202. Similarly, when the first and second caps 256, 258 are pushed into the direction of the main spoiler 274, the spoilers 254 telescope inward into the cavities of adjacent spoilers 254 to decrease the length 208 of the wiper blade 202. As shown in FIG. 22, the spoilers 254 include tabs 284 that connect to internal slots within each spoiler 254 with adjacent spoilers 254, such that when the first and second caps 256, 258 are pulled away from or pushed into the direction of the main spoiler 274, the spoilers 254 remain engaged and do not separate from one another such that there is no spacing between adjacent spoilers. Other mechanical devices of interconnecting the spoilers 254 may also be used. The spoilers 254 may also include slots 268, 270 to slidably receive the first and second splines 250, 252. Once the desired length 208 of the wiper blade 202 is reached, the consumer may rip, tear, cut or otherwise remove the excess squeegee 276 at the marking 224 that extends beyond the predetermined location 226. The first and second splines 250, 252 and the spoilers 254 are then locked into position.

### Third and Fourth Embodiments

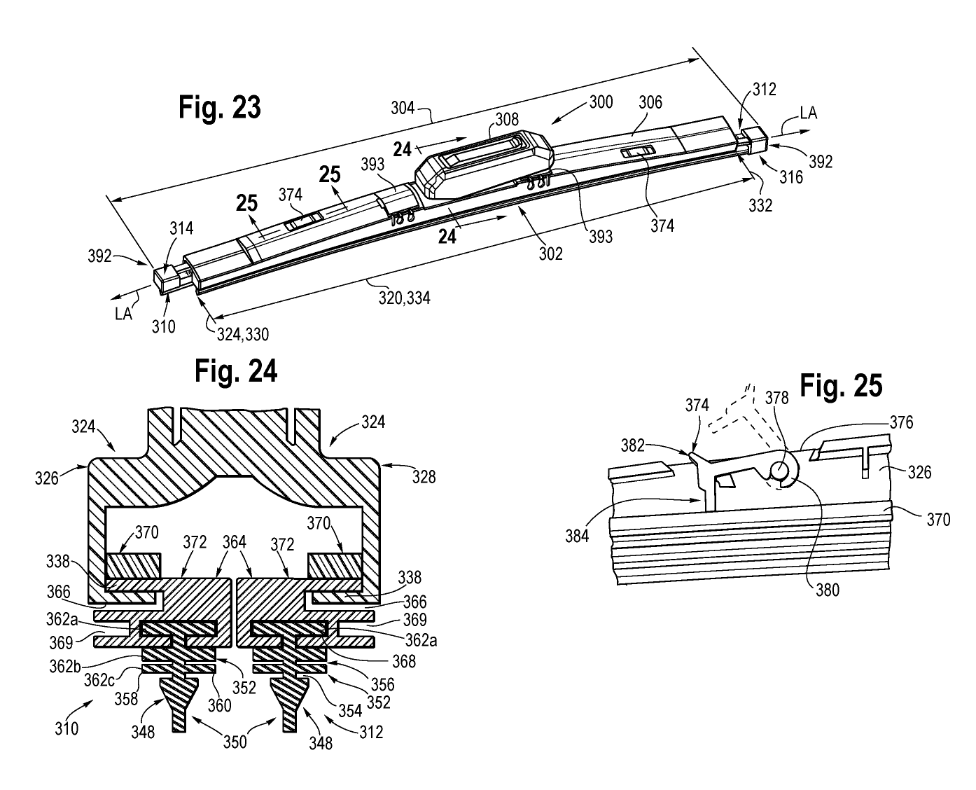

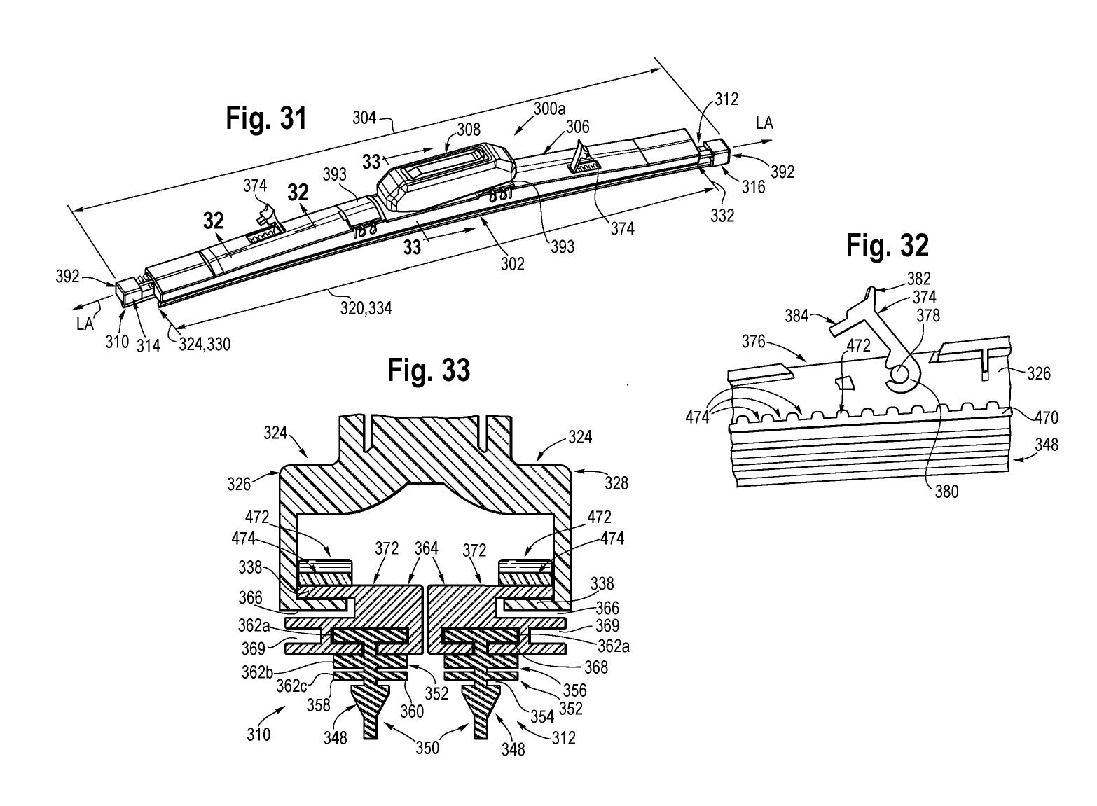

FIGS. 23-30 and 36-38C show a third embodiment of an adjustable wiper blade, and FIGS. 31-35 show a fourth embodiment of an adjustable wiper blade. The fourth embodiment of the adjustable wiper blade includes the same features as the third embodiment of the adjustable wiper blade except the fourth embodiment includes a different embodiment for an elongated locking mechanism described in more detail below. Also, FIGS. 37A-37C show an embodiment of first and second end caps, described in more detail below, that may be used with both the third and fourth embodiments of the adjustable wiper blade.

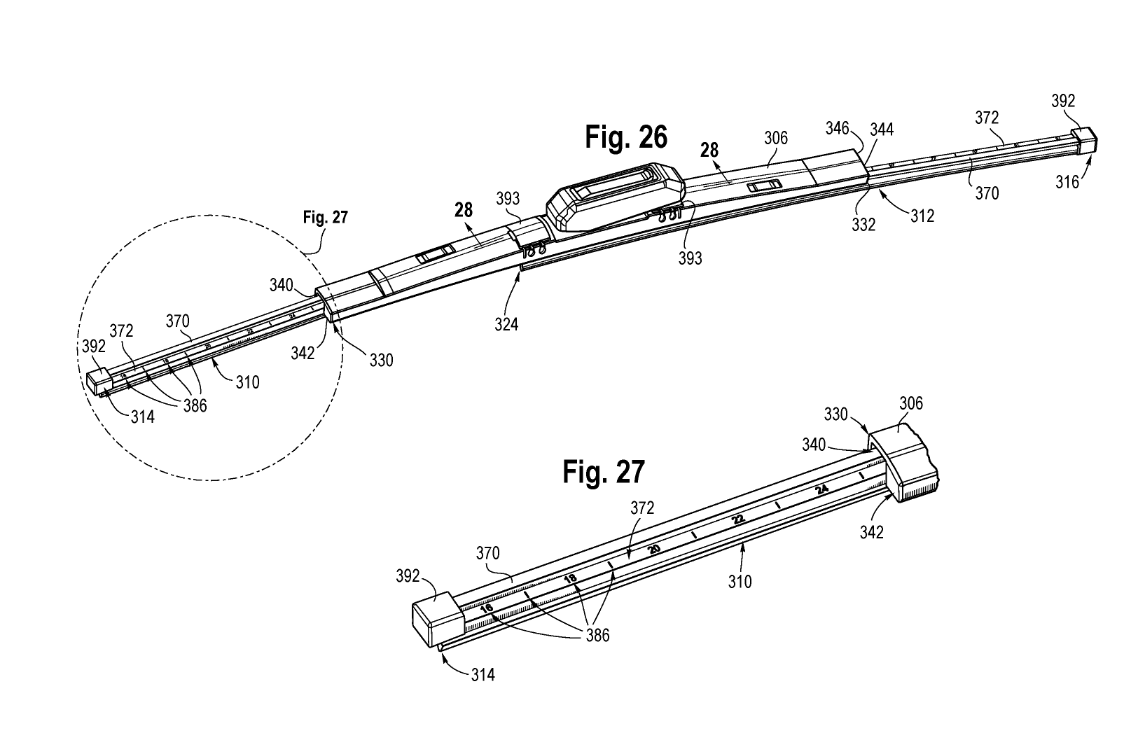

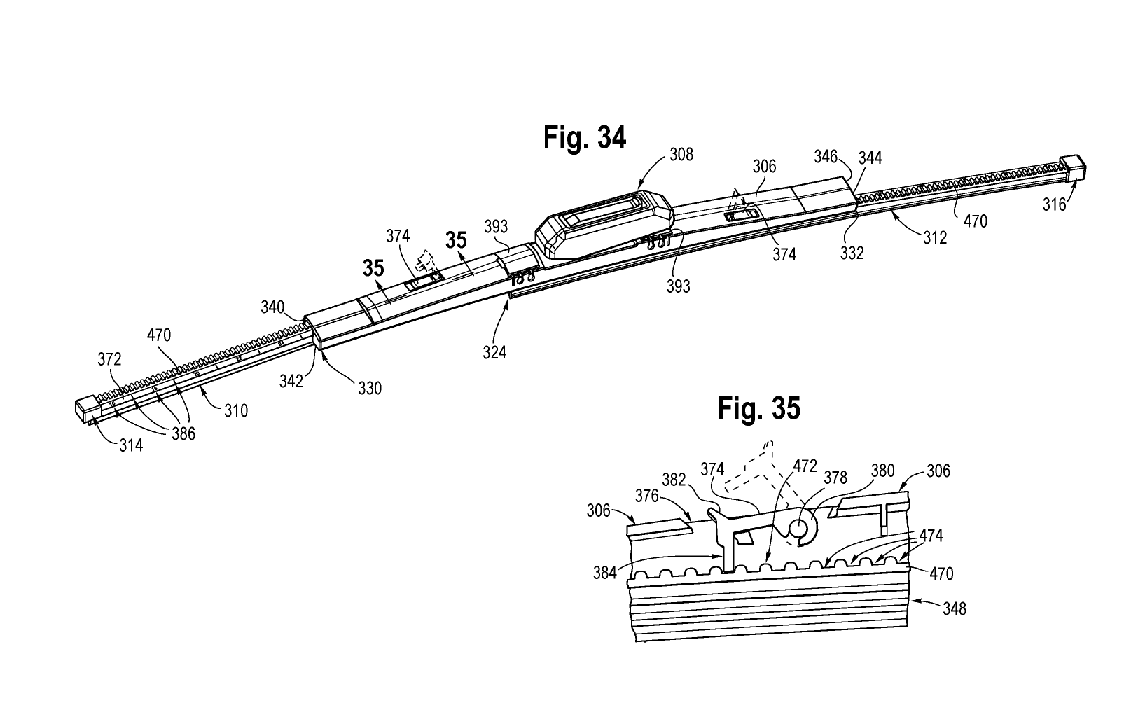

As shown in FIGS. 23-36, a device 300 (FIGS. 23-30 and 36) and a device 300a (FIGS. 31-35) include a wiper blade 302 that has an adjustable length 304, a housing 306, and a connector or adaptor 308. The wiper blade 302 includes a first blade 310 and a second blade 312 that are parallel to one another along a longitudinal axis LA of the device 300 and offset in a second direction that is perpendicular to the longitudinal axis LA. This configuration permits the first blade 310 and the second blade 312 to move relative to one another and to slide along the housing 306 when adjusting the length 304 of the wiper blade 302. The first blade 310 and the second blade 312 may be moved independently of one another. The length 304 of the wiper blade 302 is defined from a free end 314 of the first blade 310 to a free end 316 of the second blade 312. Preferably, the length 304 of the wiper blade 302 may range from 16 to 26 inches; however, the length 304 may be less than 16 or more than 26 inches to appropriate fit the windshield of an automobile. FIG. 23 shows the wiper blade 302 with a first length, and FIG. 26 shows the wiper blade 302 with a second length that is different than the first length. Similarly, FIG. 31 shows the wiper blade 302 with a first length, and FIG. 34 shows the wiper blade 302 with a second length that is different than the first length.

As shown in FIGS. 24 and 33, the offset distance 318 between the first blade 310 and the second blade 312 is the distance along the previously mentioned second direction as measured from the first blade 310 and the second blade 312. The offset distance 318 is sufficient to allow the first blade 310 and the second blade 312 to move relative to each other. The offset distance 318 may be approximately 1 mm; however, the offset distance 318 may be smaller or larger than 1 mm so long as there is sufficient distance to allow the first blade 310 and the second blade 312 to move relative to one another when adjusting the length 304 of the wiper blade 302.

The first blade 310 and the second blade 312 are both of a fixed length. The fixed length for the first blade 310 and the second blade 312 may be the same or different. Preferably, the fixed lengths of the first blade 310 and the second blade 312 may be approximately 16 inches; however the fixed lengths may be less than or greater than 16 inches to appropriately fit the windshield of an automobile. The fixed lengths of the first blade 310 and the second blade 312 are of a sufficient length such that when the wiper blade 302 is appropriately adjusted for a windshield of an automobile, areas of non-coverage during use are minimized. As shown in FIGS. 23 and 31, the first blade 310 and the second blade 312 may include an overlap length 320 defined from a second free end 322 of the first blade 310 to a second free end 324 of the second blade 312. The overlap length 320 may range from 4 inches to 14 inches; however, the overlap length 320 may be smaller or larger so long as the overlap length 320 is sufficient to prevent or minimize an area of non-coverage during use.

The first blade 310 and the second blade 312 are positioned within the housing 306 such that the first blade 310 and the second blade 312 may slide along the housing 306 along the longitudinal axis LA, as shown in FIGS. 23-24, 31, 33. The material of the housing 306 may include steel, plastic, metal, or an elastomer. The housing 306 is hollow and includes a top wall 324, a first wall 326 integral with and extending from the top wall 324, and a second wall 328 integral with and extending from the top wall 324 and parallel to the first wall 326. The housing 306 also includes a first end 330, a second end 332, a length 334 defined from the first end 330 to the second end 332, and a width 336 defined from the perpendicular distance between the first wall 326 and the second wall 328. The housing 306 may include a curved shape or profile to allow the first blade 310 and the second blade 312 to maintain a curved shape when positioned within the housing 306. Specifically, as shown in FIGS. 23, 26, 31, 34, the height of the first and second walls 326, 328 is highest in the center of the housing 306 and decreases toward the first end 330 and the second end 332 of the housing 306. The variation in height creates a curved shape for the housing 306.

The first wall 326 and the second wall 328 of the housing 306 each include a guide rail 338 that is generally parallel to the top wall 324 of the housing, as shown in FIGS. 24, 33, and 36. The guide rails 338 provide a structure for the first blade 310 and the second blade 312 to connect to the housing 306 and to slide along the housing 306 when adjusting the length 304 of the wiper blade 302. As shown in FIGS. 24 and 33, the guide rail 338 of the first wall 326 extends toward the second wall 328, and the guide rail 338 of the second wall 328 extends toward the first wall 326. The guide rails 338 extend along the length 334 of the housing 306 and include a width that is less than the width 336 of the housing 306, as shown in FIGS. 24, 33, and 36. Specifically, the width of the guide rails 338 may be approximately 0.5 cm; however, the width of the guide rails 338 may vary depending on the dimensions of a spline discussed in more detail below.

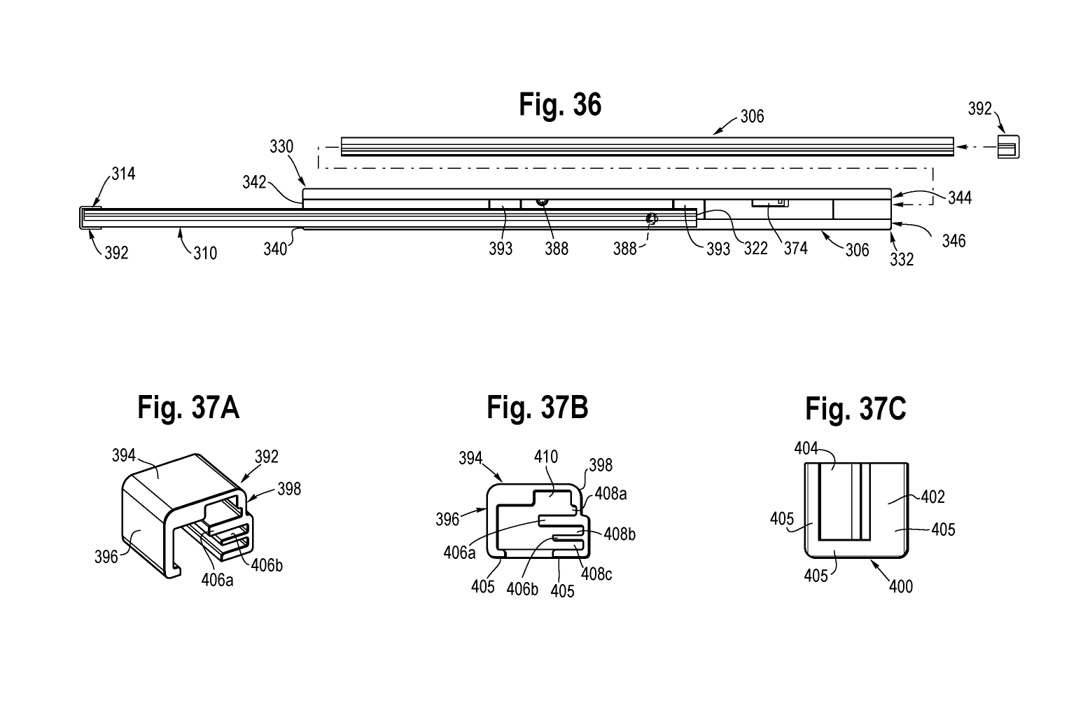

The first end 330 of the housing 306 includes an opening 340 and an end wall 342, and the second end 332 of the housing 306 also includes an opening 344 and an end wall 346, as shown in FIGS. 23, 26-27, 31, and 34. The opening 340 of the first end 330 is opposite the end wall 346 of the second end 332, and the opening 344 of the second end 332 is opposite the end wall 342 of the first end 330. As shown in FIG. 36, the opening 340 of the first end 330 allows the first blade 310 to enter the housing 306, and the end wall 346 of the second end 332 prevents the first blade 310 from sliding beyond the second end 332 of the housing 306. Similarly, the opening 344 of the second end 332 allows the second blade 312 to enter the housing 306, and the end wall 342 of the first end 330 prevents the second blade 312 from sliding beyond the first end 330 of the housing 306.

The housing 306 includes a mount or bracket 307, as shown in FIGS. 28 and 31, positioned on the top wall 324 of the housing 306 and approximately half way along the length 334 of the housing 306, or in the other words, in the center of the top wall 324 of the housing 306. The mount is configured to engage a universal connector 308 for connecting the device 300 to multiple types of wiper arms used for different types of automobiles. The mount allows the universal connector 308 to pivot. Examples of such universal connectors are described in U.S. patent application Ser. No. 14/643,255, filed on Mar. 10, 2015, U.S. patent application Ser. No. 13/836,333, filed on Mar. 15, 2013, and U.S. patent application Ser. No. 13/836,529, filed on Mar. 15, 2013, the entire contents of each of which are incorporated herein by reference.

The first blade 310 and the second blade 312 each include a squeegee 348 that contacts a windshield of an automobile to wipe the windshield, as shown in FIGS. 24 and 33. The squeegee 348 may be made of an elastomeric material such as rubber, silicone or other elastomeric material. The squeegee 348 includes a first free end, a second free end, and a length defined from the first free end to the second free end. The length of the squeegee 348 may be the same as or shorter than the fixed lengths of the first and second blades 310, 312. The squeegee 348 includes a tip 350 and a top portion 352 that are connected via a bridge 354. The top portion 352 includes one or more indentations 356 along a first side 358 and a second side 360 of the squeegee 348 that are positioned along the length of the squeegee 348. In other words, the top portion 352 includes three sections 362a, 362b, 362c with bridges 354 connecting the sections 362a, 362b, 362c. The width 362 of the top portion 352 of the squeegee 348 is defined as the distance from the first side 358 to the second side 360 of the top portion 352. The height of the bridges 354 between the sections 362a, 362b, 362c and between the top portion 352 and the tip 350 may vary.

The first blade 310 and the second blade 312 each include a spline 364 to support the first and second blades 310, 312 and to provide a connection between the first and second blades 310, 312 and the housing 306. The material of the spline 364 may include steel, plastic, metal, or an elastomer. The spline 364 includes a first free end, a second free end, and a length defined from the first free end to the second free end. The length of the spline 364 may be the same as or shorter than the fixed lengths of the first and second blades 310, 312. The length of the spline 364 may be the same as or longer than then length of the squeegee 348. The spline 364 includes a guide slot 366, a squeegee slot 368, and a side slot 369. As shown in FIGS. 24 and 33, the guide slots 366 provide a structure for the first and second blades 310, 312 to connect to and slide along the guide rails 338 of the housing 306. The squeegee slot 368 provides a structure for the squeegee 348 to connect to and slide into the spline 364. The shape of the squeegee slot 368 includes a T-shape to receive the first section 362a and adjacent bridge 354 or indentations 356 of the squeegee 248. The side slot 369 is positioned adjacent to the squeegee slot 368 and below the guide slot 366. The side slot 369 extends outwardly further than the guide line 366, as shown in FIGS. 24 and 33, such that it is almost flush with the first side wall 326 and second side wall 328 of the housing 306 to provide a counterbalance to the remainder of the spline 364.

The first blade 310 and the second blade 312 each also include an elongated locking mechanism 370, 470 to lock the first blade 310 and the second blade 312 in place. The elongated locking mechanism 370, 470 includes a first end, a second end, and a length defined from the first end to the second end. The length of the elongated locking mechanism 370, 470 is the same as or shorter than the length of the spline 364. The locking mechanism 370, 470 is attached to a top side 372 of the spline 364 of the first blade 310 and the second blade 312, as shown in FIGS. 24 and 33, via an adhesive or may be integral with the spline 364. A width of the locking mechanism 370, 470 is smaller than a width of the top side 372 of the spline 364.

In one embodiment, as shown in FIGS. 24-30, the elongated locking mechanism 370 includes an elastomeric material such as rubber, silicone or other elastomeric material. In a second embodiment, as shown in FIGS. 31-35, the elongated locking mechanism 470 includes a rack 472 that includes a series of grooves 474.

The housing 306 includes a locking element 374 for each of the first blade 310 and the second blade 312 to engage the elongated locking mechanisms 370, 470 of the first blade 310 and the second blade 312, respectively, as shown in FIGS. 23 and 26. The material of the locking element 374 may include steel, plastic, metal, or an elastomer. The locking element 374 associated with the first blade 310 is positioned adjacent to the first wall 326 of the housing 306, and the locking element 374 associated with the second blade 312 is positioned adjacent to the second wall 328 of the housing 306. For each locking element 374, the housing 306 includes an opening 376 and a bar 378. For the locking element 374 associated with the first blade 310, the bar 378 extends from the first wall 326 toward the second wall 328 of the housing, and for the locking element 374 associated with the second blade 312, the second bar 378 extends from the second wall 328 toward the first wall 326 of the housing 306. The openings 376 allow the locking element 374 to be engaged and released from the exterior of the housing 306.

As shown in FIGS. 25, 32, 35, the locking element 374 includes a first end portion, a second end portion, and a length defined from the first end portion to the second end portion. The first end portion includes a circular wrench shaped end 380 that is shaped to engage the bar 378 and to allow the locking element 374 to pivot around the bar 378. The second end portion of the locking element 374 includes a first tab 382 and a second tab 384 that extends from the first tab 382. The first tab 382 provides a structure to manually lift the locking element 374 from the exterior of the housing 306. The second tab 384 engages the elongated locking mechanism 370, 470 to secure or lock the blade 310, 312 in position.

In one embodiment, as shown in FIG. 25, in the locked position, the second tab 384 interferes with the elongated locking mechanism 370 through friction to lock the blades 310, 312 in position. In a second embodiment, as shown in FIG. 35, in the locked position, the second tab 384 interferes with the elongated locking mechanism 470 by engaging one of the series of grooves 474 to lock the blades 310, 312 in position. To transition to the open position, as shown in FIG. 32, the locking mechanism 374 is lifted from the locked position via the first tab 382 and pivots around the bar 378. In the open position, the first and second blades 310, 312 are free to move or slide along the housing 306.

The spline 364 of the first blade 310 and the second blade 312 includes a plurality of markings 386, as shown in FIGS. 26-27 and 34, at predetermined locations along the top side 372 of the spline 364. The plurality of markings 386 are located on the portion of the top side 372 of the spline 364 that is not covered by the elongated locking mechanism 370. The plurality of markings 386 are also located adjacent to the free end 314 of the first blade 310 and the free end 316 of the second blade 312 such that when the first blade 310 or the second blade 312 is adjusted and pulled away from the housing 306, the plurality of markings 386 are exposed. The plurality of markings 386 provide a visual identification of the desired lengths 304 of the wiper blade 302 that may be achieved, such as 16 to 24 inches as shown in FIGS. 26-27 and 34. Additional markings 386 may be provided to identify additional desired lengths. The plurality of markings 386 may include a line and/or a number identifying the length, such as shown in FIGS. 26-27 and 34. Other types of markings 386, such as different colors or patterns, may be used to visually identify desired lengths 304 of the wiper blade 302.

The housing 306 includes a spring plunger 388 for each of the first blade 310 and the second blade 312, as shown in FIG. 28. The spring plunger 388 engages one of a series of index slots 390, as shown in FIGS. 28-30, that are located on the spline 364 of each of the first blade 310 and the second blade 312. The index slots 390 include a groove or indentation on the top side 372 of the spline 364. The spring plunger 388 associated with the first blade 310 is positioned adjacent to the connector 308 and to the second wall 328 of the housing 306. The spring plunger 388 associated with the second blade 312 is positioned adjacent to the connector 308 and to the first wall 326 of the housing 306. The series of index slots 390 are spaced apart from each other and associated with the predetermined locations of the plurality of markings 386. Specifically, each index slot 390 is associated with one of the plurality of markings 386 such that when one of the blades 310, 312 is moved to a desired marking 386, the spring plunger 388 engages with a corresponding index slot 390. If the spring plunger 388 does not engage with an index slot 390, then the blade 310, 312 may not be properly positioned at one of the plurality of markings 386 to achieve one of the predetermined desired lengths and the blade 310, 312 may be moved and adjusted to achieve the desired position.

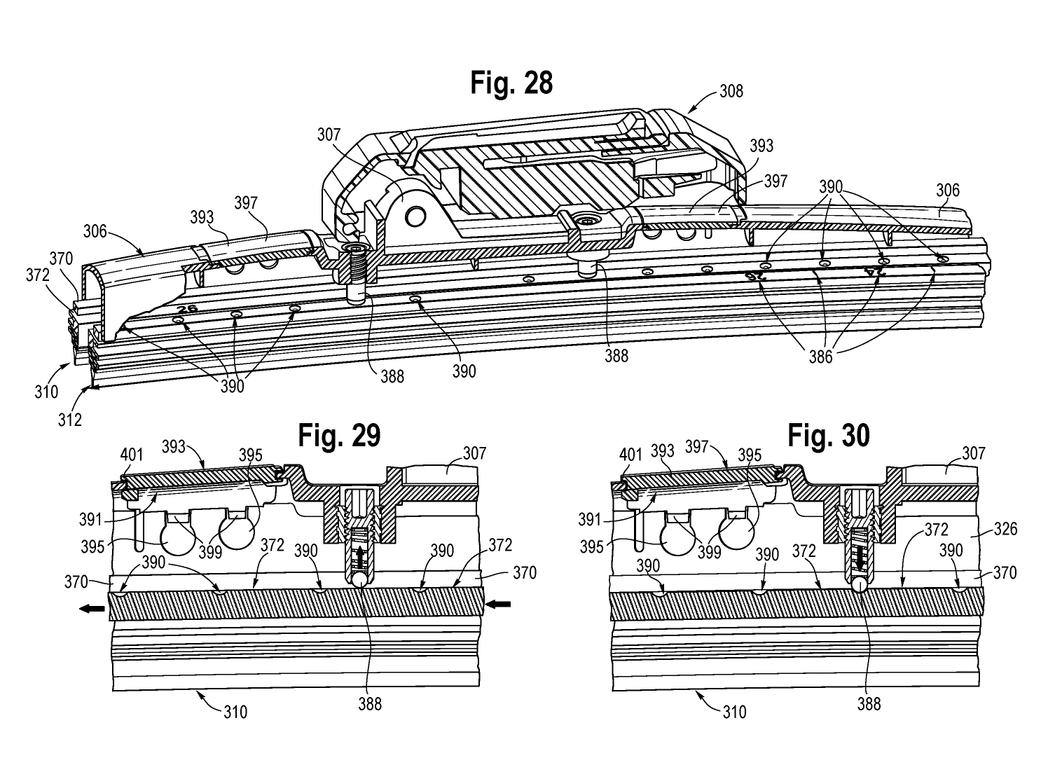

For example, as shown in FIG. 29, when the first blade 310 is moved, the movement causes the spring plunger 388 to move up and out of one of the index slots 390 to allow the first blade 310 to move freely. When the desired length of the first blade 310 is identified and the first blade 310 is properly positioned at one of the plurality markings 386 and the associated index slot 390, the spring plunger 388 engages with the groove of the index slot 390 in the spline 364, as shown in FIG. 30. As the first blade 310 moves and slides below the spring plunger 388, an audible clicking noise occurs when the spring plunger 388 engages one of the index slots 390. The audible clicking noise provides positive feedback that the first blade 310 is properly positioned within one of the index slots 380 and accordingly at the corresponding marking 386. The spring plunger 388 also secures the blades 310, 312 into position.

The housing 306 may include two openings 391 that are spaced apart and positioned in the top wall 324 of the housing 306 adjacent to the connector 308. For example, as shown in FIGS. 28 and 29, one opening 391 is positioned underneath the connector 308 and the second opening 391 adjacent to the opposite end of the connector 308. The openings 391 allow access to the interior of the housing 306 toward the center of the housing 306 and provide a visual of the spring plungers 388 to determine whether the spring plungers 388 are properly positioned in one of the index slots 390.

Each opening 391 also includes two pairs of circular cutouts 395 that extend from the opening 391 onto the first and second side walls 326, 328 of the housing 306. Specifically, one pair of circular cutouts 395 is positioned on the first side wall 326 and the second pair of circular cutouts 395 is positioned on the second side wall 328 of the housing 306, as shown in FIGS. 23, 26, 28-31, and 34. Each opening 391 includes a cover piece 393 for covering the opening 391. The cover piece 393 is a curved square shaped element that includes a main body 397 and two pairs of tabs 399 positioned on two sides of the cover piece 393 that extend in a perpendicular direction from the main body 397. The two pairs of tabs 399 allow the cover piece 393 to snap into the two pairs of circular cutouts 395. When the cover piece 393 is snapped into the opening 391, the cover piece 393 is flush with the top wall 324 of the housing 306. The cover piece 393 may include one or more additional tabs 401, as shown in FIGS. 23, 26, 28-31, and 34, on the remaining two sides of the cover piece 393 to secure the cover piece 393 to the housing 306. In an alternative embodiment, openings 391, cover pieces 393, cutouts 395, main bodies 397, tabs 399 and additional tabs 401 can be omitted without departing from the spirit of the present invention.

The device 300 includes end caps 392, as shown in FIGS. 23, 31, 34, and 36-38C. The end caps 392 provide a structure to pull and push the first blade 310 and the second blade 312. The material of the end caps 392 may include steel, plastic, metal or an elastomer. The end caps 392 are dimensioned to be larger than the openings 340, 344 of the first end 330 and second end 322, respectively, of the housing 306 to stop or prevent the first blade 310 and the second blade 312 from sliding entirely into the housing 306. As shown in FIG. 23, for example, an end cap 392 is positioned on the free end 314 of the first blade 310, and an end cap 392 is positioned on the free end 316 of the second blade 312. End caps 392 are not positioned at the second free ends 322, 324 of the first blade 310 and the second blade 312, respectively, because the second free ends 322, 324 of the first blade 310 and the second blade 312, respectively, are positioned within the housing 306 and the end caps 392 do not fit within the housing 306.

As shown in FIGS. 37A-37C, the end caps 392 are designed to conform to the design of the splines 364 at the free ends 314, 316 of the first and second blades 310, 312, respectively. The end caps 392 may be secured to the free ends 314, 316 via an adhesive or may be integral with the free ends 314, 316 of the first and second blades 310, 312, respectively.

The end caps 392 have a hollow square shaped structure including a top wall 394, a first side wall 396 that extends from and is integral with the top wall 392, a second side wall 398 that is generally parallel to the first side wall 396 and extends from and is integral with the top wall 392, an end wall 400 that is perpendicular to the first and second side walls 396, 398 and extends from and is integral with the top wall 392, and a bottom wall 402 that is parallel to the top wall 392. As shown in FIG. 37C, the bottom wall 402 has a square or rectangular shaped opening 404 to accommodate the squeegee 348 such that the squeegee 348 may pass through the opening 404. The opening 404 forms three tabs 405 in the bottom wall 402 that are positioned below the bottom of the spline 364 when the end cap 392 is positioned on the blade 310, 312 to secure the end cap 392 to the spline 364. In other words, the top wall 392, first and second side walls 396, 398, and the bottom wall 402, including the three tabs 405, encapsulate or wrap around the spline 364 when the end cap 392 is positioned on the blade 310, 312.

Each end cap 392 also includes two tabs 406a, 406b positioned within the hollow portion of the end cap 392 that are spaced apart and parallel to each other, as shown in FIGS. 37A-37B. The two tabs 406a, 406b extend from the second side wall 398 toward the first side wall 396 and are also parallel to the top wall 394 and the bottom wall 402. The two tabs 406a, 406b create three openings 408a, 408b, 408c such that the two tabs 406a, 406b slide into the guide slot 366 and the side slot 369 of the spline 364, as shown in FIGS. 24 and 33, and the walls of the guide slot 366 and the side slot 369 may receive the three openings 408a, 408b, 408c. The end cap 392 also includes an opening 410 positioned above and slightly offset from the opening 408a to accommodate the elongated locking mechanism 370,470 when the end cap 392 is positioned on the blade 310, 312. The second side wall 398 includes a step 412 to accommodate the side slot 369 as the side slot 369 extends further than the guide slot 366.

To adjust the length 304 of the wiper blade 302, the first blade 310 and/or the second blade 312 may be moved. To move the first blade 310, the locking element 374 of the first blade 310 may be lifted via the first tab 382 of the locking element 374 and moved into the unlocked position such that the locking element 374 is released from the elongated locking mechanism 370, 470. The first blade 310 may then be pulled away from the housing 306 via the end cap 392 to increase the length 304 of the wiper blade 302 or pushed into the housing 306 via the end cap 392 to decrease the length 304 of the wiper blade 302. To achieve a desired position, the first blade 310 is moved until the first blade 310 is positioned such that one of the plurality of markings 386 is aligned with the first end 330 of the housing 306, and the spring plunger 388 engages one of the index slots 390, which may be audibly identified. To confirm the spring plunger 388 has engaged one of the index slots 390, the cover 393 may be removed to view through the opening 391 that the spring plunger 388 has engaged one of the index slots 390. The first blade 310 may be moved until the spring plunger 388 has engaged one of the index slots 390. The cover 393 may then be positioned over the opening 391, and the first blade 310 may be locked into the desired position by pushing the locking element 374 down via the first tab 382 to engage the elongated locking mechanism 370, 470 into the locked position. In an alternative embodiment, the locking element 374 may be pushed down via the first tab 382 into the locked position to lock the first blade 310 into the desired location without confirming the positioning of the spring plunger 388 via the opening 391 and the cover 393. The second blade 312 may also be moved to adjust the length 304 of the wiper blade 302. To move the second blade 312, the locking element 374 of the second blade 312 may be lifted via the first tab 382 of the locking element 374 and moved into the unlocked position. The second blade 312 may then be pulled away from the housing 306 via the end cap 392 to increase the length 304 of the wiper blade 302 or pushed into the housing 306 via the end cap 392 to decrease the length 304 of the wiper blade 302. To achieve a desired position, the second blade 312 is moved until the second blade 312 is positioned such that one of the plurality of markings 386 is aligned with the second end 332 of the housing 306, and the spring plunger 388 engages one of the index slots 390, which may be audibly identified. As described above regarding the first blade 310, the positioning of the spring plunger 388 may be confirmed by removing the cover 393 and viewing the spring plunger 388 through the opening 391. The cover 393 may then be positioned over the opening 391, and the locking element 374 is pushed down via the first tab 382 into the locked position to lock the second blade 312 into the desired location. In an alternative embodiment, the locking element 374 may be pushed down via the first tab 382 into the locked position to lock the second blade 312 into the desired location without confirming the positioning of the spring plunger 388 via the opening 391 and the cover 393.

### Fifth Embodiment

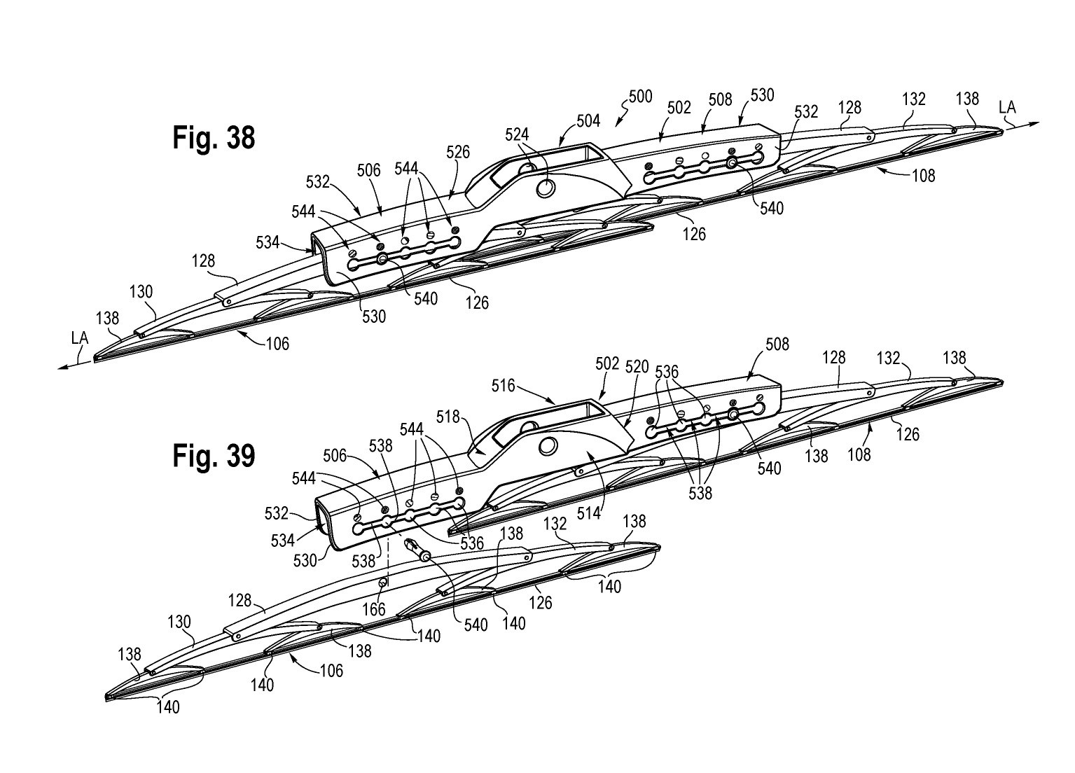

FIGS. 38-42 show a fifth embodiment of an adjustable wiper blade, which includes a device 500. The fifth embodiment is similar to the first embodiment except for the design of the housing. The device 500 includes a wiper blade 102 and a housing 502 that is removably connected to the wiper blade 102. The material of the housing 502 may include steel, plastic, metal or an elastomer. The wiper blade 102 includes a first blade 106 and a second blade 108 that are spaced apart and parallel to each other, as shown in FIGS. 38-42. The first blade 106 and the second blade 108 each include a conventional blade, such as a so-called bridge blade or a beam blade, and are both of a fixed length. FIGS. 38-42 show the first blade 106 and the second blade 108 as a bridge blade. The description of the bridge blades provided above regarding the first embodiment applies to the fifth embodiment and the reference numbers of the elements of the first embodiment for the first blade 106 and the second blade 108 are referred to herein regarding the fifth embodiment, and accordingly, the description of the first blade 106 and the second blade 108 is not repeated in its entirety herein regarding the fifth embodiment.

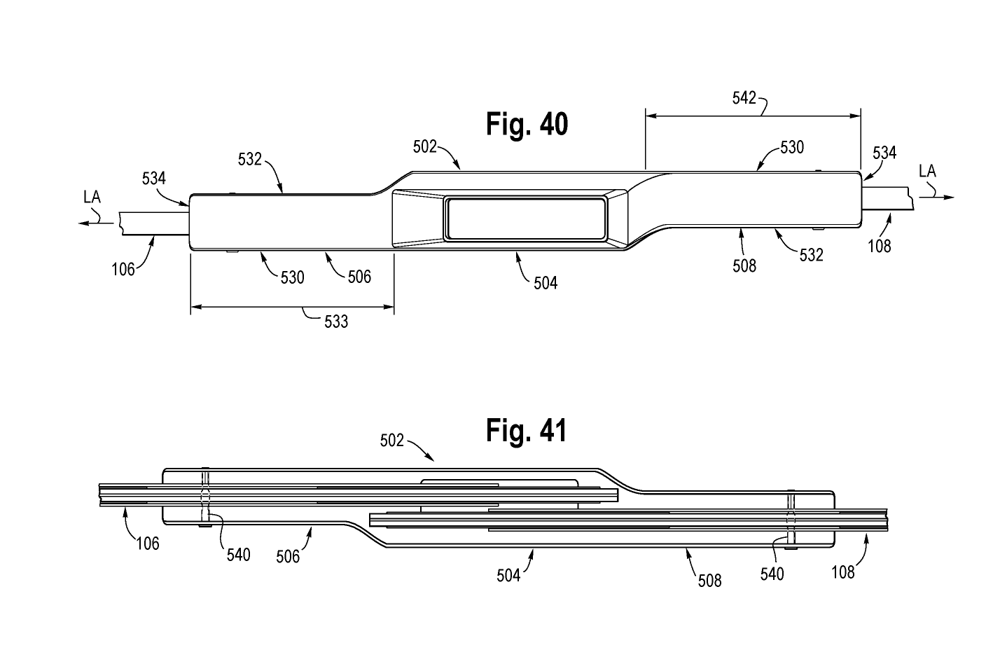

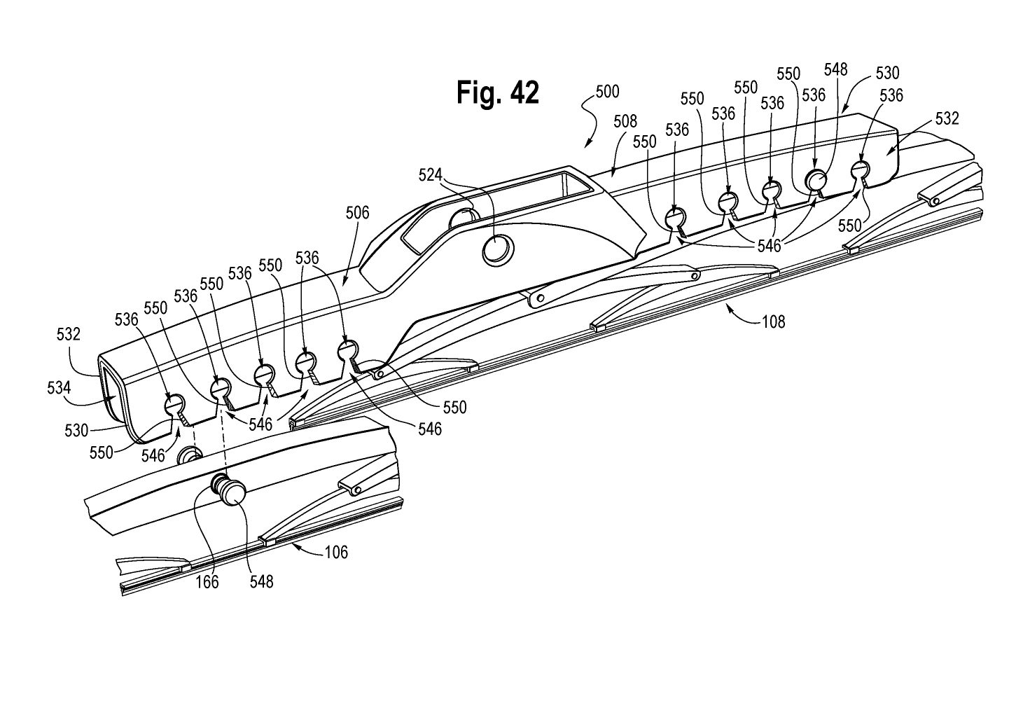

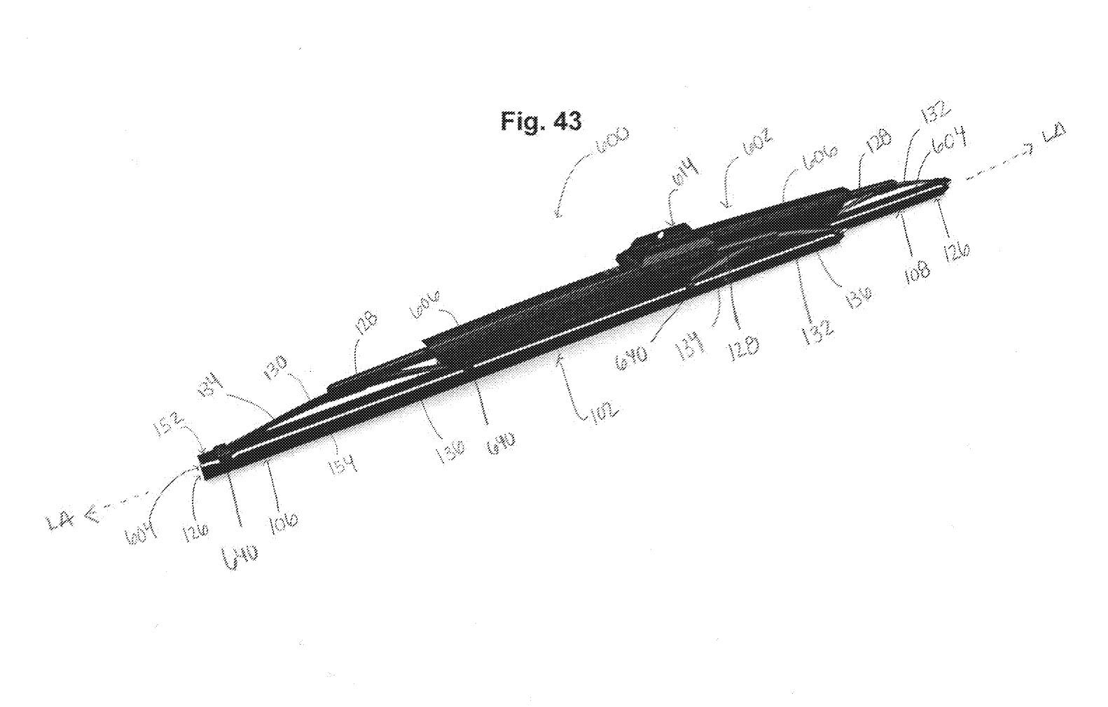

The housing 502 includes an S-shaped design, as shown in FIGS. 40-41. The S-shape design provides a stream-lined housing that minimizes the amount of material used for the housing. Specifically, the housing 502 includes a main body 504, a first extension 506 that is integral with the main body 504 and extends along a longitudinal axis LA from the main body 504, and a second extension 508 that is integral with the main body 504, extends along the longitudinal axis LA in the opposite direction of the first extension 506, and is offset a distance from the first extension 506 such that the second extension 508 is parallel to the first extension 506. The first blade 106 is positioned within the first extension 506, and the second blade 108 is positioned within the second extension 508. The first extension 506 and the second extension 508 are offset a distance and parallel to each other to allow the first blade 106 and the second blade 108 to maintain the offset distance 118 between the blades 106, 108, as shown in FIG. 42, such that the blades may move relative to each other without interference. The first and second blades 106, 108 may move independently of each other.

The main body 504 of the housing 502 includes a bracket 510 configured to engage a connector or adaptor (not shown) for connecting the housing 502 to multiple types of wiper arms used for different types of automobiles. The connector may include a universal adaptor, as described previously above regarding the first through fourth embodiments, or a connector configured to receive a J-hook wiper arm. Examples of such universal connectors are described in U.S. patent application Ser. No. 14/643,255, filed on Mar. 10, 2015, U.S. patent application Ser. No. 13/836,333, filed on Mar. 15, 2013, and U.S. patent application Ser. No. 13/836,529, filed on Mar. 15, 2013, the entire contents of each of which are incorporated herein by reference.

In one embodiment, as shown in FIGS. 38-40 and 42, the bracket 510 is configured to receive a connector for a J-hook wiper arm. The bracket 510 may include a generally square or rectangular shape with a hollow center. The bracket 510 includes a base wall 512, four side walls 514, 516, 518, 520 that extend from the base wall 512, and an open top 522 to receive the J-hook wiper arm. The side walls 514, 516 that extend along the longitudinal axis LA each include an opening 524 that is used to manipulate and engage the connector.

The first extension 506 has a U-shape that includes a top wall 526 that is integral with and extends from the base wall 512 of the bracket 510 along the longitudinal axis LA for a length 528. The first extension 506 includes a first side wall 530 and a second side wall 532 that are parallel to each other and both extend from the top wall 526 in a direction perpendicular to the longitudinal axis LA for a length 533 to form an opening 534 to receive the first blade 106.

The second extension 508 is offset from the first extension 506 and parallel to the first extension 506, as shown in FIGS. 41-42. The second extension 508 initially extends from the base wall 512 of the bracket 510 in a direction perpendicular to the longitudinal axis LA to offset the second extension 508 from the first extension 506. After initially extending in a direction perpendicular to the longitudinal axis LA, the second extension 508 extends for a length 542 along the longitudinal axis LA in the opposite direction of the first extension 506 to form an S-shape configuration with the main body 504 and the second extension 508. The second extension 508 has the same U-shape design as the first extension 506 that includes the top wall 526 that is integral with the base wall 512 of the bracket 510. The second extension 508 also includes the first side wall 530 and the second side wall 532 that are parallel to each other and both extend from the top wall 526 in a direction perpendicular to the longitudinal axis LA to form the opening 534 to receive the second blade 108.

The first side wall 530 and the second side wall 532 of the first and second extensions 506, 508 each include a series of circular openings 536 that are spaced apart from each other and connected to each other via rectangular openings 538. The circular openings 536 are positioned at predetermined desired locations for specific lengths 112 of the wiper blade 102. The first side wall 530 and the second side wall 532 of the first and second extensions 506, 508 also include a plurality of markings 544 associated with each of the circular openings 536. Each marking 544 includes a design or color that is associated with a specific length 112 of the wiper blade 102. The device 500 may include a key code or manual that identifies which marking 544 is associated with a specific length 112 for the wiper blade 102.

As shown in FIG. 40, a pin 540 is used to connect the opening 166 of the first blade 106 with one of the series of circular openings 536 to attach the first blade 106 to the housing 504. Likewise, a pin 540 is used to connect the opening 168 of the second blade 108 with one of the series of circular openings 536 to attach the second blade 108 to the housing 504. The pin 540 may vary in diameter along its length such that when the pin 540 is pushed into one of the circular openings 536, the blade 106, 108 is locked into position. To move one of the blades 106, 108 from one circular opening 536 to a second circular opening 536, the pin 540 is pulled slightly out of the circular opening 536 and can slide along the rectangular openings 537 until a desired location is identified. When the blade 106, 108 is positioned at a desired position at one of the circular openings 536, the pin 540 may be pushed into the circular opening 536 to lock the blade 106, 108 into position. Therefore, to adjust the length 112 of the wiper blade 102, one or both of the first and second blades 106, 108 may be moved.

In another embodiment, as shown in FIG. 43, the housing 504 has the same shape and configuration as described with respect to FIGS. 39-42, except the connection between the first and second blades 106, 108 to the housing 504 and the markings identifying the desired location lengths 112 of the wiper blade 102 are different. Specifically, the series of circular openings 536 located on the first side wall 530 and the second side wall 532 of the first and second extensions 506, 508 are not connected to each other. The circular openings 536 each include a V-shaped extension opening 546 that extends from the circular opening 536 in a direction perpendicular to the longitudinal axis LA. The extension openings 546 include a plurality of markings 550 associated with each of the extension openings 546. Each marking 550 includes a design or color that is associated with a specific length 112 of the wiper blade 102. The device 500 may include a key code or manual that identifies which marking 550 is associated with a specific length 112 for the wiper blade 102.

A pin 548 is positioned within the openings 166, 168 of the first and second blades 106, 108. The pin 548 includes a circular shaped body having a first end, a second end, and a main body connecting the first end to the second end. The diameter of the main body is smaller than the diameter of the first end and the second end. The design of the pin 428 allows the pin 428 to snap into one of the circular openings 536 via the extension opening 546 and to secure the blades 106, 108 in place at a desired position. The diameter of the first and second ends of the pin 548 is greater than the diameter of the circular openings 536 to prevent the pin 548 from sliding out of the circular openings 536, as shown in FIG. 43.

To move one of the blades 106, 108 from one circular opening 536 to a second circular opening 536, the pin 548 and corresponding blade 106, 108 is pulled out of the circular opening 536 and the extension opening 546 and then pushed into the extension opening 546 and snapped into the circular opening 536 at a desired location. To adjust the length 112 of the wiper blade 102, one or both of the first and second blades 106, 108 may be moved.

### Sixth Embodiment

FIGS. 43-49B show a sixth embodiment of an adjustable wiper blade, which includes a device 600. The sixth embodiment is similar to the first and fifth embodiments except for the design of the housing and the addition of a spline 604 positioned within longitudinal grooves or the indentations 150 of the squeegee 126 positioned on the first side 152 and the second side 154 of the squeegee 126, described in more detail below. The device 600 includes a wiper blade 102, a housing 602 that is removably connected to the wiper blade 102, and a pair of covers 606 that are removably connected to the housing 602. The material of the housing 602 may include steel, plastic, metal or an elastomer.

The wiper blade 102 includes a first blade 106 and a second blade 108 that are spaced apart and parallel to each other, as shown in FIGS. 43-47. The first blade 106 and the second blade 108 each include a conventional blade, such as a so-called bridge blade, a beam blade or a hybrid blade, and are both of a fixed length. FIGS. 43-47 show the first blade 106 and the second blade 108 as a hybrid blade, which, in this embodiment, includes a bridge blade with the spline 604. The description of the bridge blades provided above regarding the first embodiment applies to the sixth embodiment and the reference numbers of the elements of the first embodiment for the first blade 106 and the second blade 108 are referred to herein regarding the sixth embodiment, and accordingly, the description of the first blade 106 and the second blade 108 is not repeated in its entirety herein regarding the sixth embodiment. As shown in FIGS. 43-47, in one embodiment, the first and second arms 134, 136 of each sub-frame 130, 132 of the frame 128 do not include a sub-sub-frame 138. However, in another embodiment of device 600, the first and second arms 134, 136 of each sub-frame 130, 132 may include a sub-sub-frame 138, as shown in FIGS. 1-4 and described regarding the first embodiment, and in such alternative embodiment, the spline 604 may be included or omitted.

The spline 604 may include one or two elongated elements having a length and a width. The length of the spline 604 is the same as or longer than the horizontal length 156 of the squeegee 126. In one embodiment, as shown in FIGS. 43, 46-47, the spline 604 includes two elongated elements, one positioned within the longitudinal groove or indentation 150 on the first side 152 of the squeegee 126 and the other positioned within the longitudinal groove or indentation 150 on the second side 154 of the squeegee 126. In an alternative embodiment, the spline 604 includes one elongated element including an opening to receive the top portion 148 of the squeegee 126 such that the spline 604 is positioned within the longitudinal grooves or indentations 150 on the first side 152 and the second side 154 of the squeegee 126 and the portion of the top portion 148 above the longitudinal grooves or indentations 150 is positioned above the opening of the spline 604.

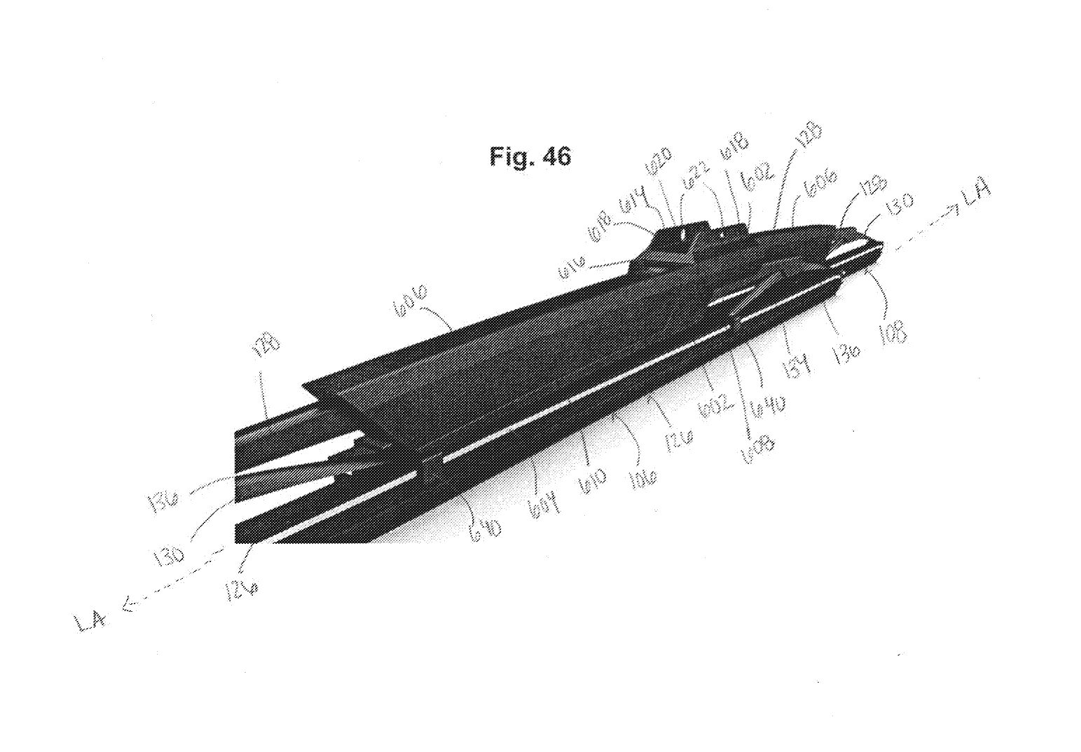

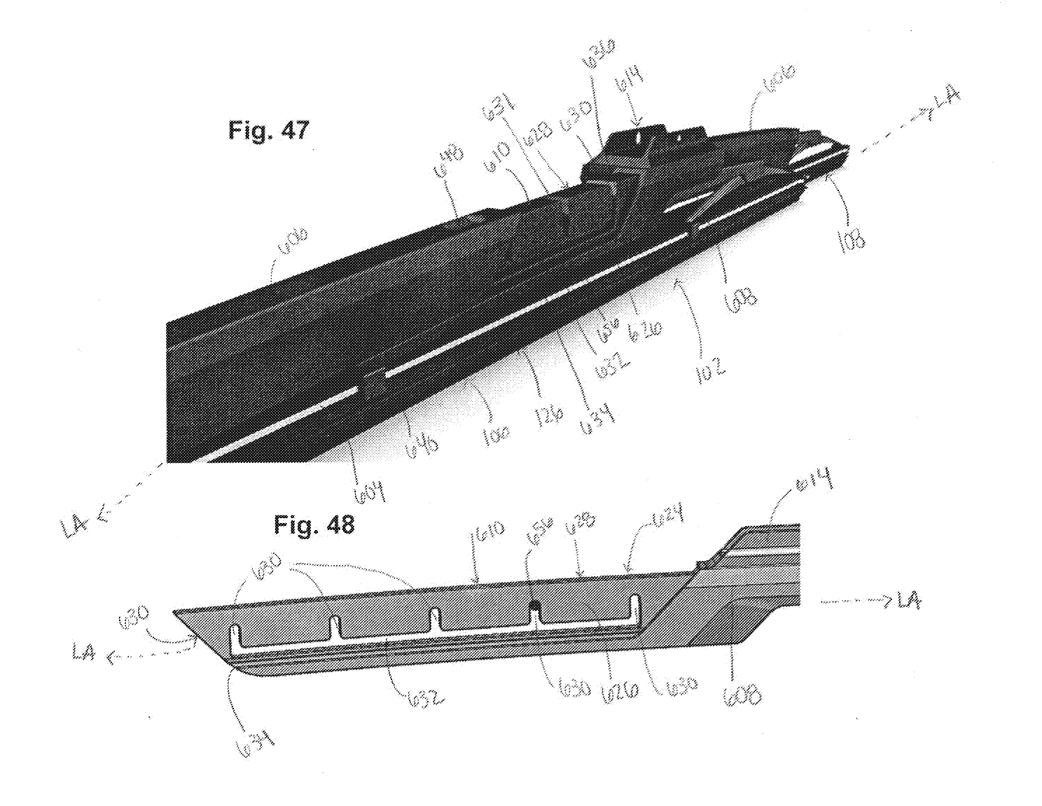

The first and second arms 134, 136 of each sub-frame 130, 132 may include a clamp-shaped end 640 to connect the sub-frames 130, 132 to the first blade 106 and to the second blade 108 and to hold the spline 604 within the longitudinal grooves or indentations 150 on the first and second sides 152, 154 of the squeegee 126, as shown in FIGS. 43, 45-47. The clamp-shaped ends 640 wrap around the top portion 148 of the squeegee 126 and the spline 604 on the first and second side 152, 154 of the squeegee 126 and insert into the longitudinal grooves or indentations 150 on the first and second sides 152, 154 of the squeegee 126 that are positioned below the longitudinal grooves or indentations 150 of the squeegee 126 that the spline 604 is positioned, as shown in FIGS. 46-47. In an alternative embodiment, the clamp-shaped ends 640 may engage the spline 604 to secure the spline 604 into the longitudinal grooves or indentations 150 of the squeegee 126.

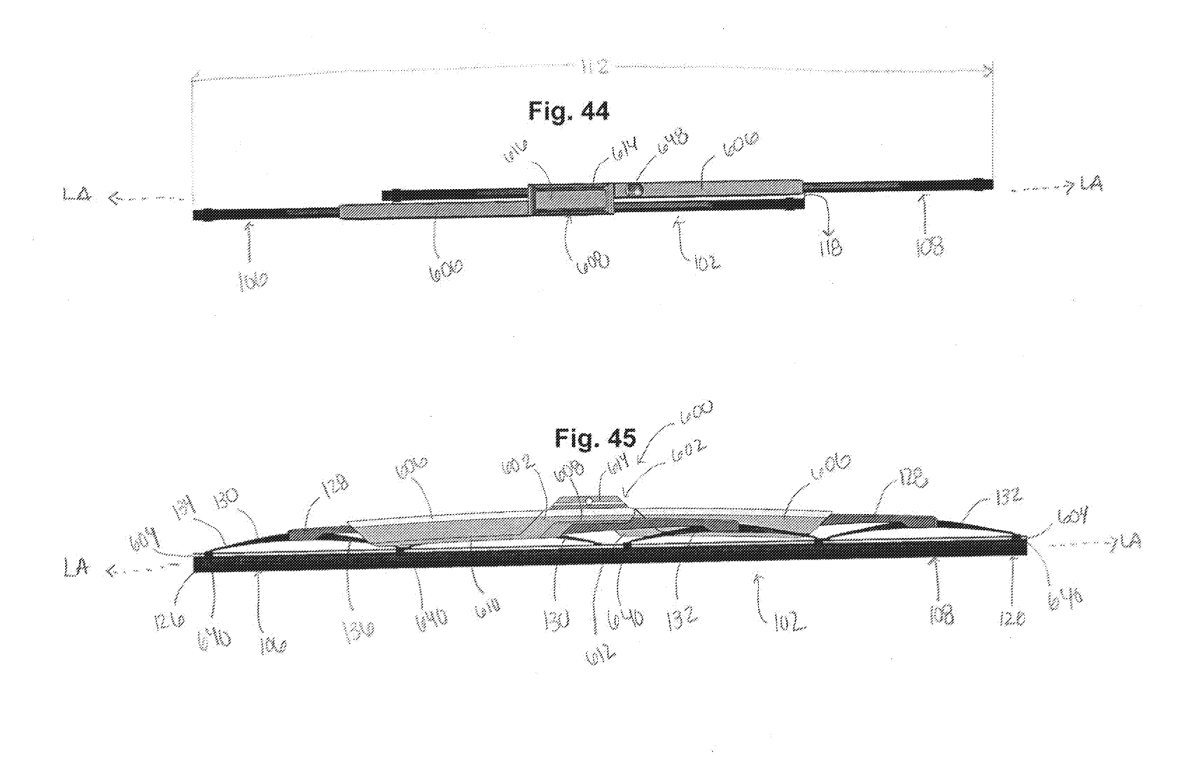

The housing 602 includes an S-shaped design, as shown in FIGS. 43-44 and 46-47. The S-shape design provides a stream-lined housing that minimizes the amount of material used for the housing. Specifically, the housing 602 includes a main body 608, a first extension 610 that is integral with the main body 608 and extends along a longitudinal axis LA from the main body 608, and a second extension 612 that is integral with the main body 608, extends along the longitudinal axis LA in a direction opposite the direction of the first extension 610, and is offset a distance 118 from the first extension 610 such that the second extension 612 is parallel to the first extension 610. As shown in FIGS. 44 and 46-47, the main body 608 includes a top wall, two side walls extending from the top that are parallel to each other and extend from the top wall in a direction perpendicular from the longitudinal axis LA, and an open bottom to receive the first blade 106 and the second blade 108.

The main body 608 of the housing 602 includes a bracket 614 positioned on the top wall of the main body 608 and configured to engage a connector or adaptor (not shown) for connecting the housing 602 to multiple types of wiper arms used for different types of automobiles. As shown in FIGS. 43-47, the bracket 614 is integral with the main body 608 of the housing 602. In an alternative embodiment, the bracket 614 may be removably connected to the main body 608 of the housing 602. The connector may include a universal adaptor, as described previously above regarding the first through fifth embodiments, or a connector configured to receive a J-hook wiper arm. Examples of such universal connectors are described in U.S. patent application Ser. No. 14/643,255, filed on Mar. 10, 2015, U.S. patent application Ser. No. 13/836,333, filed on Mar. 15, 2013, and U.S. patent application Ser. No. 13/836,529, filed on Mar. 15, 2013, the entire contents of each of which are incorporated herein by reference. In one embodiment, as shown in FIGS. 43, 45-47, the bracket 614 includes a base wall 616, two side walls 618 that extend from the base wall 616 and along the longitudinal axis LA, and an open top 620 to receive the connector or adaptor. The side walls 618 each include an opening 622 that is used to manipulate and engage the connector.

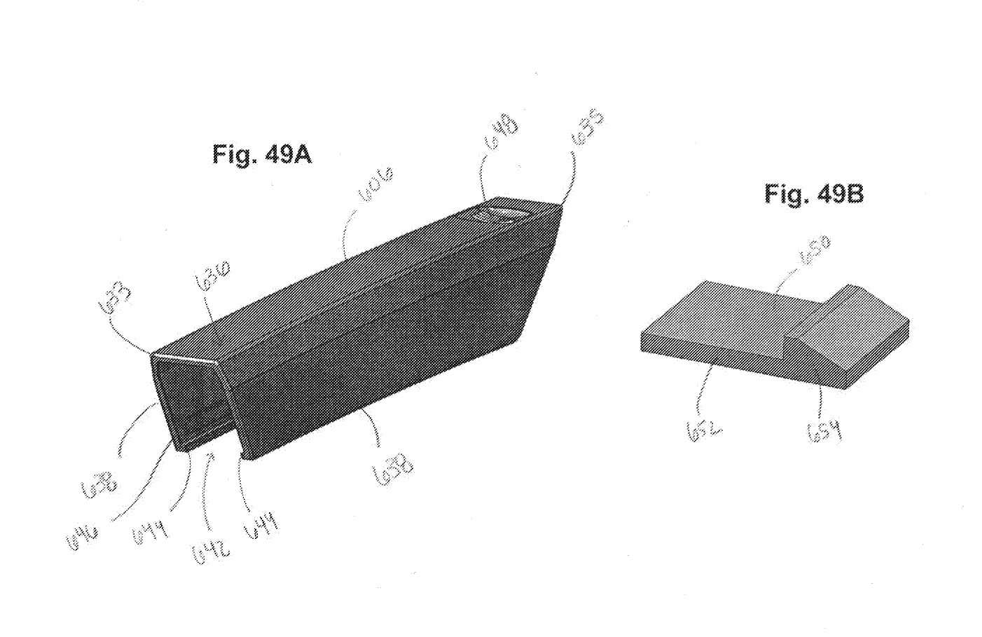

The first and second extensions 610, 612 each have a U-shape that includes a top wall 624 and a first side wall 626 and a second side wall 628 that are parallel to each other and both extend from the top wall 624 in a direction perpendicular to the longitudinal axis LA, as shown in FIGS. 47-48, to form an opening 630 to receive either the first blade 106 or the second blade 108. The first blade 106 is positioned within the first extension 610, and the second blade 108 is positioned within the second extension 612. The first extension 610 and the second extension 612 are offset a distance and parallel to each other to allow the first blade 106 and the second blade 108 to maintain the offset distance 118 between the blades 106, 108, as shown in FIG. 44, such that the blades may move relative to each other without interference. The first and second blades 106, 108 may move independently of each other. As described previously, the first extension 610 and the second extension 612 are integral with the main body 608 of the housing 602.

The first and second side walls 626, 628 of the first and second extensions 610, 612 each include a series of vertical slots 630 and a horizontal slot 632 that connects the vertical slots 630, as shown in FIGS. 47-48. The vertical slots 630 are positioned at predetermined locations along the first and second extensions 610, 612 to achieve a desired length 112 of the wiper blade 102. In an alternative embodiment, the vertical slots may include circular openings 536 that each include a V-shaped extension opening 546 the extends from the circular opening 536, as shown in FIG. 42, and described above regarding the fifth embodiment. As shown in FIG. 48, the length of the horizontal slot 632 is shorter than the length of the first extension 610 and the second extension 612 to prevent the pin 656, described in more detail below, from sliding and moving off of the first and second extensions 610, 612. The first and second side walls 626, 628 of the first and second extensions 610, 612 also each include a groove 634. The groove 634 is parallel to the horizontal slot 632 and extends along the length of the first and second side walls 626, 628, as shown in FIGS. 47-48.

The first and second extensions 610, 612 also include a plurality of markings 631. As shown in FIG. 47, the plurality of markings 631 are positioned above the vertical slots 630 and each marking 631 is associated with a vertical slot 630. Each marking 631 includes a design or color that is associated with a specific length 112 of the wiper blade 102. The device 500 may include a key code or manual that identifies which marking 631 is associated with a specific length 112 for the wiper blade 102. In an alternative embodiment, the plurality of markings may include the markings 544, as shown in FIG. 39, described above regarding the fifth embodiment. In another alternative embodiment, the plurality of markings are positioned within the vertical slots 630 similar to described above regarding the markings 550, as shown in FIG. 42, and described above regarding the fifth embodiment.

As described above, the device 600 also includes a pair of covers 606 that are removably connected to the housing 602. The material of the covers 606 may include steel, plastic, metal or an elastomer. The material of the covers 606 may be the same material as the material of the housing 602. One cover 606 may slide over the first extension 610 of the housing 602 and the other cover 606 may slide over the second extension 612 of the housing 602, as shown in FIGS. 43-47. FIG. 49A shows an embodiment of the cover 606. The cover 606 includes a U-shape including a first end 633, a second end 635, a top wall 636 that extends from the first end 633 to the second end 635, and a pair of side walls 638 that are parallel to each other and extend from the top wall 636. The U-shape of the cover 606 forms a bottom opening 642 to position the first blade 106 or the second blade 108 with the bottom opening 642. The side walls 638 each include a longitudinal extension or lip 644 that extends along the length of the side walls 638. As shown in FIG. 49A, the longitudinal extension or lip 644 of one side wall 638 also extends toward the opposite side wall 638 for a distance. The longitudinal extension or lip 644 slides into the groove 634 of the first and second extensions 610, 612, as shown in FIG. 47. The side walls 638 also each include a rail 646 positioned above the longitudinal extension or lip 644 that extends along a portion of or the entire length of the side walls 638. When the cover 606 is positioned on either the first extension 610 or the second extension 612, the rail 646 prevents a pin 656, described in more detail below, from sliding or otherwise moving out of one of the vertical slots 630.

The cover 606 also includes a locking element to lock the cover 606 over the first extension 610 or the second extension 612. The locking element includes an indentation 648, as shown in FIG. 49A, and a tab 650, as shown in FIG. 49B. The indentation 648 is located within the top wall 636 of the cover 606 and adjacent to the second end 635 of the cover 606. The tab 650 includes a first section 652 and a second section 654. The first section 652 includes a square or rectangular shaped extension, and the second section 654 includes a protrusion. The first section 652 of the tab 650 is positioned below or underneath the top wall 636 of the cover 606 and adjacent to the second end 635 of the cover 606 such that the second section 654 extends beyond the second end 635 of the cover 606. The tab 650 may be integral with the cover 606 or secured to the cover 606 may an adhesive or a mechanical connection, such as a nut and a bolt.

The protrusion of the second section 654 of the tab 650 is designed to engage a slot (not shown) within the main body 608 of the housing 602 such that the second section 654 snaps into the slot to secure the cover 606 to the housing 602. Specifically, one slot is positioned within the main body 608 adjacent to the first extension 610 to engage the second section 654 of the tab 650 of the cover 606 positioned over the first extension 610, and a second slot is positioned within the main body 608 adjacent to the second extension 612 to engage the second section 654 of the tab 650 of the cover 606 positioned over the first extension 612. To release the cover 606 from the slot, the indentation 648 may be pushed down to release the second section 654 of the tab 650 from the slot and pulled away from the main body 608 of housing 602.

As shown in FIGS. 47-48, a pin 656 is used to connect the opening 166 of the first blade 106, as shown in FIG. 2, with one of the series of vertical slots 630 to attach the first blade 106 to the first extension 610 of the housing 602. Likewise, a pin 656 is used to connect the opening 168 of the second blade 108, as shown in FIG. 2, with one of the series of vertical slots 630 to attach the second blade 108 to the second extension 612 of the housing 602. Specifically, the pin 656 is positioned within the openings 166, 168 of the first and second blades 106, 108. The pin 656 includes a circular shaped body having a first end, a second end, and a main body connecting the first end to the second end. The diameter of the main body is smaller than the diameter of the first end and the second end. The design of the pin 656 allows the pin 656 to snap into one of the vertical slots 630 and to secure the first and second blades 106, 108 in place at a desired position. The diameter of the first and second ends of the pin 656 is greater than the width of the vertical slots 630 to prevent the pin 656 from sliding out of the circular openings 536, as shown in FIG. 47. As described above, when the cover 606 is positioned over the first or second extensions, 610, 612, the rail 646 prevents the pin 656 from sliding or otherwise moving out of one of the vertical slots 630.

To change the length 112 of the wiper blade 102, the first blade 106 and/or the second blade 108 may be moved. For example, to move the first blade 106 from a first predetermined location to a second predetermined location different than the first predetermined location, the locking mechanism of the cover 606 is released from the slot of the main body 608 of the housing 602 and pulled away from the main body 608. The cover 606 may be pulled to slide off the first extension 610 entirely or partially depending on the position of the second predetermined location. When the cover 606 is removed from the first extension 610, the rail 646 of the cover 606 is no longer positioned below the pin 656. The pin 656 is pushed to snap out or otherwise slide down the vertical slots 630 on the first side wall 626 and the second side wall 628 of the first extension 610 at the first predetermined location, and then the pin 656 is pushed to slide along the horizontal slots 632 of the first and second side walls 626, 628 until the pin 656 is positioned below the vertical slot 630 at the desired second predetermination location. The pin 656 is positioned within the opening 166 of the first blade 106 such that when the pin 656 moves, the first blade 106 also moves. The pin 656 is then pushed to slide up and snap into the vertical slots 630 on the first and second side walls 626, 628 of the first extension 610 at the second predetermined location. The cover 606 is positioned over the first extension 610 by sliding the longitudinal extensions or lips 644 of the walls 638 of the cover 606 within the grooves 634 of the first and second side walls 626 and 628 of the first extension 610. The second section 654 of the tab 650 of the cover 606 is then pushed or snapped into the slot of the main body 608 of the housing 602 to secure the cover 606 to the housing 602 and over the first extension 610. When the cover 606 is secured to the housing 602, the rail 646 locks the pin 656 and thus the first blade 106 into the second predetermined location by preventing the pin 656 from sliding or otherwise moving out of the vertical slots 630. The same steps may be used to move the second blade 108.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A device comprising:
a wiper blade, wherein a length of said wiper blade as measured from a first end of said wiper blade to a second end of said wiper blade is adjustable without removal of material of said wiper blade; and
a housing removably connected to said wiper blade.

2. The device of claim 1, wherein said wiper blade comprises a first blade and a second blade that are parallel to one another.

3. The device of claim 2, wherein said first blade comprises a spline with a guide slot.

4. The device of claim 3, wherein said first blade is slidably connected to said housing via said guide slot of said spline so that said first blade moves relative to said second blade and so that a distance between a free end of said first blade and a free end of said second blade changes.

5. The device of claim 3, wherein said housing comprises a plunger;
wherein said spline comprises a plurality of slots arranged along a length of said first blade; and
wherein said plunger engages one of said plurality of slots so that a desired length of said wiper blade is achieved.

6. The device of claim 3, wherein said first spline comprises an elongated locking mechanism that extends along a length of said spline; and
wherein said housing comprises a locking element to engage said elongated locking mechanism.

7. The device of claim 6, wherein said locking element pivots to engage said elongated locking mechanism.

8. The device of claim 1, wherein said device further comprises a locking element comprising a pin that is inserted into said housing.

9. The device of claim 6, wherein said elongated locking mechanism comprises a rack comprising a series of grooves; and wherein said locking element engages one of said grooves.

10. The device of claim 3, wherein said spline comprises a plurality of markings that identify predetermined positions for said length of said wiper blade.

11. The device of claim 2, wherein said first blade comprises a squeegee.

12. A method of adjusting a length of a wiper blade, said method comprising:
providing a wiper blade having a first length; and
adjusting said wiper blade to have a second length different in magnitude than said first length without removal of material of said wiper blade.

13. The method of claim 12, wherein said providing comprises locating said wiper blade having said first length at a first predetermined position.

14. The method of claim 12, wherein said adjusting comprises moving said wiper blade to a second predetermined position different than said first predetermined position; and said method further comprising locking said wiper blade at said second predetermined position.

15. The method of claim 12, wherein said wiper blade comprises a first blade and a second blade that are parallel to one another.

16. The method of claim 15 comprising positioning said first blade at a first predetermined position and positioning said second blade at a second predetermined position; and
wherein said first length of said wiper blade comprises a length defined from a free end of said first blade at said first predetermined position to a free end of said second blade at said second predetermined position.

17. The method of claim 16, wherein said adjusting said wiper blade comprises moving said first blade to a third predetermined position and locking said first blade at said third predetermined position; and
wherein when said first blade is locked at said third predetermined position, said second length of said wiper blade comprises a length defined from said free end of said first blade to said free end of said second blade.

18. The method of claim 16, wherein said adjusting said wiper blade comprises moving said second blade to a fourth predetermined position and locking said second blade at said fourth predetermined position.

19. A device comprising:
a wiper blade, wherein a length of said wiper blade is adjustable via relative movement of two parallel blades; and
a housing connected to said two parallel blades, wherein said housing comprises a plurality of predetermined locations for connection between said housing and said two parallel blades.

20. The device of claim 19, wherein said housing comprises a plurality of markings that identify the plurality of predetermined locations for connection between said housing and said two parallel blades.
